(19) United States
(12) Patent Application Publication
(10) Pub. No.: US 2026/0238124 A1
(43) Pub. Date: Aug. 13, 2026

(54) CASCADE SUPPLY GENERATOR AND SUPPLY MODULATOR AND RELATED CIRCUITS AND TECHNIQUES

(71) Applicant: Murata Manufacturing Co., Ltd., Kyoto (JP)

(72) Inventors: John R. Hoversten, Arlington, MA (US); David J. Perreault, Cambridge, MA (US); Muneharu Kato, Nagaokakyo (JP); Kouji Yamaguchi, Nagaokakyo (JP); Taichi Yamaguchi, Cambridge, MA (US); Aaron Cook, Windham, NH (US)

(73) Assignee: Murata Manufacturing Co., Ltd., Kyoto (JP)

(21) Appl. No.: 19/530,935

(22) Filed: Feb. 5, 2026

Related U.S. Application Data
(60) Provisional application No. 63/757,126, filed on Feb. 11, 2025.

(51) Int. Cl. H02M 3/07

(52) U.S. Cl. CPC H02M 3/07

(57) ABSTRACT

Described are concepts, systems, circuits, devices, methods, and techniques directed toward power management and control. In particular, described are concepts, systems, circuits, methods, and techniques for utilizing a linear regulator and a switched capacitor converter to provide power management and control for supplying multiple configurable output voltages to a supply modulation.

### CROSS-REFERENCE TO RELATED APPLICATIONS

This application claims the benefit of priority under 35 U.S.C. § 119 of U.S. Provisional Patent Application No. 63/757,126, filed on Feb. 11, 2025, which is hereby incorporated by reference herein in its entirety.

### BACKGROUND

The efficiency of radio-frequency (RF) power amplifiers (PAS) can be improved through “supply modulation” (or “drain modulation” or “collector modulation”), in which the power supply voltage provided to the PA is adjusted dynamically (“modulated”) over time depending upon the RF signal being synthesized. For the largest efficiency improvements, supply voltage can be adjusted discretely (among discrete levels) or continuously on a short time scale that tracks or dynamically accommodates rapid variations in RF signal amplitude (or envelope), such as may occur as data is encoded in the RF signal or as the RF signal amplitude is desired to be changed with high envelope bandwidth (e.g., as in envelope tracking, envelope tracking advanced, polar modulation, “class G” power amplification, multilevel backoff, multilevel linear amplifier with nonlinear components (LINC), Asymmetric Multilevel Outphasing (AMO), etc.). The power supply voltage (or voltage levels) provided to the PA may also be adapted to accommodate longer-term changes in desired RF envelope (e.g., “adaptive bias,” “adaptive power tracking” (APT)) such as associated with adapting transmitter output strength to minimize errors in data transfer, for RF “traffic” variations, etc.

“Continuous” supply modulation (e.g., “envelope tracking” or “adaptive bias”) may be advantageously realized by dynamically selecting an intermediate voltage from among a set of discrete power supply voltages and then further regulating (stepping down) this intermediate voltage to create a continuously-variable supply voltage to be provided to the PA, or by pulse-width modulating between two or more levels and filtering the output to create a continuously-varying waveform.

Some RF amplifier systems utilize “discrete” supply modulation (or discrete “drain modulation”) in which the supply voltage is switched among a set of discrete voltage levels, possibly including additional filtering or modulation to shape the voltage transitions among levels. Systems of this type include “class G” amplifiers, multilevel LINC (MLINC) power amplifiers, AMO power amplifiers, multilevel backoff amplifiers (including “asymmetric multilevel backoff” amplifiers) and digitized polar transmitters among other types. Hybrid systems which utilize a combination of continuous and discrete supply modulation may also be realized.

### SUMMARY

Described herein are concepts, systems, circuits, devices, methods, and techniques for use in and/or with PA architectures. The described concepts, systems, circuits, devices, methods, and techniques may provide very rapid variations in modulated power supply voltage (e.g., among multiple discrete levels). The described concepts, systems, circuits, devices, methods, and techniques may also provide the ability to slowly adapt the voltages of the discrete levels over a desired range. The described concepts, systems, circuits, devices, methods, and techniques may provide high performance power supplies in PA architectures at lower cost and/or at reduced size as compared to prior solutions. Such concepts, systems, circuits, devices, methods, and techniques may find use in a number of applications including, but not limited to PA architectures.

The concepts, systems, circuits, devices, methods, and techniques described herein may provide substantially all (or most) of the practical benefits available from supply modulation (e.g., in terms of PA efficiency) while at the same time avoiding limitations associated with providing truly independent voltage level control. Thus, the concepts, systems, circuits, devices, methods, and techniques described herein may provide significant advantages in combinations of size, cost, efficiency and performance as compared to existing approaches.

Further benefits may be provided by coupling a controllable linear regulator, such as a controllable low dropout (LDO) voltage regulator, between an energy source and a cascaded switched capacitor converter and supply modulator. Such a power supply architecture may provide for flexibility in controlling voltage levels to output from the power supply, while reducing cost and/or space requirements (e.g., given the smaller size of components in a linear regulator as opposed to a magnetic and/or capacitive power converter) as compared to other power supply architectures.

In accordance with some embodiments, a system is provided. The system has a pair of input terminals configured to be connected to terminals of an energy source and has a pair of output terminals configured to be connected to a radio frequency (RF) amplifier. The system comprises a linear regulator configured to draw power at the input terminals and to output a regulated voltage. The system also comprises a switched capacitor converter coupled to the output of the linear regulator. The system further comprises a supply modulator coupled to the output of the switched capacitor converter.

In some embodiments, the system further comprises a controller and a digital interface coupled between the controller and at least one of the linear regulator or the switched capacitor converter and used to modify operation of at least one of the linear regulator or switched capacitor converter.

In further embodiments, the system further comprises a controller and a digital interface coupled between the controller and the supply modulator, wherein the controller is configured to control the supply modulator via the digital interface.

In still further embodiments, the digital interface is a digital control level (DCL) interface.

In some embodiments, the switched capacitor converter is reconfigurable.

In further embodiments, at least one of the switched capacitor converter, the regulated voltage output from the linear regulator, or a connection point between the linear regulator and the switched capacitor converter is reconfigurable.

In still further embodiments, the switched capacitor converter is reconfigured by changing a connection point at which the linear regulator is coupled to the switched capacitor converter.

In some embodiments, the linear regulator is one of a plurality of linear regulators having different connection points to the switched capacitor converter, wherein which of the linear regulators actively regulates its output is reconfigurable.

In further embodiments, the switched capacitor converter is reconfigured by changing its switching pattern.

In still further embodiments, the system further comprises a controller configured to control the linear regulator to output the regulated voltage at a selected voltage level.

In some embodiments, the system further comprises a controller. The controller is configured to receive one or more signals representing one or more output voltage levels of the switched capacitor converter, and control the linear regulator to output a selected voltage level to the switched capacitor converter, thereby adjusting one or more voltage levels output from the switched capacitor converter to one or more reference voltage levels.

In further embodiments, an output reference of the linear regulator is selected from among multiple discrete regulation points.

In still further embodiments, the switched capacitor converter is reconfigurable to output at least one of a plurality of different sets of voltage levels related to the regulated voltage.

In some embodiments, voltages of the plurality of different sets of voltage levels are proportional to the regulated voltage.

In further embodiments, the switched capacitor converter is configured to maintain at least three voltage rails, wherein a voltage difference between a first of the voltage rails and a second of the voltage rails is the same as a voltage difference between the second of the voltage rails and a third of the voltage rails.

In still further embodiments, the switched capacitor converter is configured to output a set of voltage levels comprising at least the regulated voltage, two thirds of the regulated voltage, and one third of the regulated voltage.

In some embodiments, the switched capacitor converter is configured to output a set of voltage levels comprising the regulated voltage and one half of the regulated voltage.

In further embodiments, the switched capacitor converter comprises a first stage and a second stage coupled together by at least two voltage rails.

In still further embodiments, one of the at least two voltage rails comprises a voltage of zero volts.

In some embodiments, the switched capacitor converter comprises a first stage coupled between the regulated voltage output by the linear regulator and a ground voltage, and a second stage differentially coupled between the regulated voltage output by the linear regulator and a voltage level output by the first stage.

In further embodiments, the switched capacitor converter is configured to output a set of voltage levels comprising a voltage greater than the regulated voltage.

In still further embodiments, the system further comprises a controller. The controller is configured to control the linear regulator to output the regulated voltage at a selected voltage level, and to control the switched capacitor converter to output a set of different voltage levels proportional to the regulated voltage to the supply modulator.

In some embodiments, the switched capacitor converter is reconfigurable to operate in an operating mode.

In further embodiments, the switched capacitor converter is reconfigurable to operate in at least two different operating modes, a first of the at least two operating modes outputting a first set of voltage levels proportional to the regulated voltage, and a second of the at least two different operating modes outputting a second set of voltage levels proportional to the regulated voltage, the second set being different from the first set.

In still further embodiments, the switched capacitor converter generates at least two different sets of voltage levels proportional to the regulated voltage.

In some embodiments, at least one of the at least two different sets of voltage levels includes at least two different voltage levels.

In further embodiments, the switched capacitor converter comprises a network of switches and capacitors. The system further comprises a controller. The controller is configured to control the network of switches to reconfigure the switched capacitor converter to operate in one of at least two different operating modes, wherein the switched capacitor converter generates at least two sets of voltage levels proportional to the regulated voltage.

In still further embodiments, the energy source is a variable voltage source.

In some embodiments, the variable voltage source is a battery.

In further embodiments, the controller is further configured to detect a voltage level of the energy source, and select the voltage level of the regulated voltage based on the detected voltage level.

In still further embodiments, the system further comprises a controller. The controller is configured to detect a voltage level of the energy source, and reconfigure the switched capacitor converter to output the one of the plurality of different sets of voltage levels related to the regulated voltage to the supply modulator based on the detected voltage level.

In some embodiments, the system further comprises a controller. The controller is configured to detect a voltage level of the energy source, select a voltage level of the regulated voltage based on the detected voltage level, and reconfigure the switched capacitor converter to output at least one of a plurality of different sets of voltage levels proportional to the regulated voltage to the supply modulator based on the detected voltage level.

In further embodiments, the system further comprises a controller. The controller is configured to detect a voltage level of the energy source, and reconfigure the switched capacitor converter to operate in one of at least two different operating modes based on the detected voltage level.

In still further embodiments, the system further comprises a controller. The controller is configured to receive a signal related to at least one of a voltage level of the energy source or a desired RF output power of the RF amplifier, and select a voltage level of the regulated voltage and/or reconfigure the switched capacitor converter based on the received signal.

In some embodiments, the system further comprises a controller. The controller is configured to receive a signal related to a voltage level output by the switched capacitor converter to the supply modulator, and select a voltage level of the regulated voltage and/or reconfigure the switched capacitor converter based on the received signal.

In further embodiments, the linear regulator is a first linear regulator of a plurality of linear regulators and the regulated voltage is a first regulated voltage. The system further comprises a controller. The controller is configured to receive a signal related to at least one of a voltage level of the energy source or a desired RF output power of the RF amplifier, and control one of the linear regulators other than the first linear regulator to draw power at the input terminals and to output a second regulated voltage different than the first regulated voltage to the switched capacitor converter.

In still further embodiments, the system further comprises a controller. The controller is configured to control the linear regulator to output the regulated voltage at a selected level based on an operating mode of the switched capacitor converter.

In some embodiments, the supply modulator comprises a first supply modulator, further comprising a second supply modulator coupled to the output of the switched capacitor converter.

In further embodiments, the RF amplifier transmits at least one of WiFi signals or cellular signals.

In still further embodiments, the linear regulator is a low drop-out (LDO) linear regulator.

In some embodiments, the linear regulator comprises a metal oxide semiconductor (MOS) transistor device.

In further embodiments, the switched capacitor converter comprises lumped element capacitors and integrated circuit (IC) transistors.

In still further embodiments, at least one of the linear regulator or the switched capacitor converter can be programmatically reconfigured by a controller.

In some embodiments, the supply modulator can be controlled to select a voltage of zero volts.

In further embodiments, the system further comprises a controller, wherein at least one of the linear regulator or the switched capacitor converter can be reconfigured by the controller based on a signal received by the controller from a digital pre-distortion (DPD) circuit.

In still further embodiments, the RF amplifier comprises a first RF amplifier and the supply modulator comprises a first supply modulator, the system further comprising a second supply modulator, wherein the first supply modulator and the second supply modulator are coupled to the output of the switched capacitor converter, the first supply modulator is coupled to the first RF amplifier, and the second supply modulator is coupled to a second RF amplifier.

In some embodiments, the supply modulator comprises a first supply modulator, the system further comprising a second supply modulator, wherein each of the first supply modulator and the second supply modulator are coupled via a pulse-shaping network (PSN) to a single RF amplifier.

In further embodiments, an output of the supply modulator is coupled to an output stage of the RF amplifier, and a level of the switched capacitor converter is coupled to a driver stage of the RF amplifier.

In still further embodiments, the supply modulator comprises a first supply modulator, the system further comprising a second supply modulator, wherein the first supply modulator is configured to supply a first voltage level from the switched capacitor converter to a first stage of the RF amplifier, and the second supply modulator is configured to supply a second voltage level from the switched capacitor converter to a second stage of the RF amplifier.

In some embodiments, the system further comprises a filtering circuit coupled between the supply modulator and the RF amplifier, the filtering circuit comprising at least an impedance.

In further embodiments, the impedance comprises at least one of a resistor, capacitor, or inductor.

In still further embodiments, the impedance comprises at least one of a lumped element or a distributed element.

In some embodiments, the supply modulator comprises a plurality of switches and is coupled to the RF amplifier, wherein the supply modulator is configured such that current from the output of the switched capacitor converter passes through only one of the plurality of switches before reaching the RF amplifier.

In further embodiments, the supply modulator comprises at least one N-channel metal oxide semiconductor (NMOS) transistor or at least one P-channel metal oxide semiconductor (PMOS) transistor.

In still further embodiments, the supply modulator comprises at least one transistor, and a gate of the at least one transistor is driven by a voltage level at the output of the switched capacitor converter.

In some embodiments, the supply modulator comprises a network of switches, further comprising a controller, the controller configured to control the switches in the supply modulator to select one of multiple voltages output by the switched capacitor converter to couple the selected voltage to the RF amplifier.

In further embodiments, the supply modulator comprises a first supply modulator, further comprising a second supply modulator coupled to the output of the switched capacitor converter, wherein the first supply modulator is configured to couple a first voltage output by the switched capacitor converter to a first RF amplifier, and wherein the second supply modulator is configured to couple a second voltage output by the switched capacitor converter to a second RF amplifier.

Before explaining example embodiments consistent with the present disclosure in detail, it is to be understood that the disclosure is not limited in its application to the details of constructions and to the arrangements set forth in the following description or illustrated in the drawings. The disclosure is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

The accompanying drawings, which are incorporated in and constitute part of this specification, and together with the description, illustrate and serve to explain the principles of various example embodiments.

FIG. 1A is a diagram of an example radio frequency (RF) power amplifier (PA) system utilizing multiple supply levels and supply modulators to select from the multiple supply levels to supply multiple PAs.

FIG. 1B is a diagram of an example RF amplifier system including a multiple-output supply generator comprising a single-input multiple-output (SIMO) boost converter, a supply modulator, and a filter.

FIG. 2A is a diagram of an example switching network for implementing a series supply modulator.

FIG. 2B is a diagram of an example switching network for implementing a parallel supply modulator.

FIG. 3 is a diagram of an example supply modulator with a cascaded turn-off switch.

FIG. 4 is a diagram of an example implementation of a series supply modulator, such as the series supply modulator of FIG. 2A.

FIG. 5 is a diagram of an example system utilizing magnetic power converters to provide multiple supply levels.

FIG. 6 is a diagram of an example system utilizing a linear regulator and a magnetic power converter to provide multiple supply levels.

FIG. 7 is a diagram of an example system utilizing a linear regulator and a switched capacitor converter to provide multiple supply levels.

FIG. 8A is a diagram of an example switched capacitor converter.

FIG. 8B is a diagram of another example switched capacitor converter.

FIG. 9 is a diagram of an example system utilizing a linear regulator and a switched capacitor converter to provide multiple supply levels.

FIG. 10 is a diagram of an example system utilizing a linear regulator and a switched capacitor converter to provide ratiometric supply levels.

FIG. 11 is a diagram of an example system utilizing a linear regulator and two stages of a switched capacitor converter to provide ratiometric supply levels.

FIG. 12A is a diagram of an example system utilizing multiple linear regulators and two stages of a switched capacitor converter to provide ratiometric supply levels.

FIG. 12B is a diagram of an example system utilizing multiple linear regulators and two stages of a switched capacitor converter to provide ratiometric supply levels, where one of the supply levels powers a driver stage of an amplifier and another one of the supply levels powers a final stage of an amplifier.

FIG. 13A is a diagram of an example system utilizing a linear regulator and two stages of a switched capacitor converter to provide ratiometric supply levels, where a connection point of an output of the linear regulator to the switched capacitor converter can be reconfigured via switches.

FIG. 13B is a diagram of an example system utilizing a linear regulator and two stages of a switched capacitor converter to provide ratiometric supply levels, where a connection point of an output of the linear regulator to the switched capacitor converter can be reconfigured via switches, and where a driver stage of an amplifier is powered by one of the supply levels and a final stage of the amplifier is powered by another one of the supply levels.

FIG. 14 is a diagram of an example reconfigurable switched capacitor converter.

FIG. 15 is a diagram of an example interleaved reconfigurable switched capacitor converter.

FIG. 16 is a diagram of an example reconfigurable ladder switched capacitor converter.

FIG. 17 is a diagram of an example system for supplying different supply levels from multiple supply levels to drive two different amplifiers.

### DETAILED DESCRIPTION

Reference will now be made in detail to the embodiments of the disclosure, certain examples of which are illustrated in the accompanying drawings.

In the following description, numerous specific details are set forth regarding the concepts, systems, circuits, devices, methods, and techniques of the disclosed subject matter, and the environment in which such concepts, systems, circuits, devices, methods, and techniques operate, to provide a thorough understanding of the disclosed subject matter. After reading the descriptions provided herein, it will be apparent to one skilled in the art, however, that the disclosed subject matter may be practiced without such specific details. It will also be apparent to one skilled in the art that certain features, which are well known within the art, are not described in detail to avoid unnecessary complication of the description of the concepts, systems, circuits, devices, methods, and techniques described herein. In addition, it will be understood that the embodiments provided below are examples, and that it is contemplated that there are other concepts, systems, circuits, devices, methods, and techniques that are within the scope of the subject matter disclosed herein.

The disclosure herein includes discussion of certain concepts that would be understood by one of ordinary skill in the art, and so are not discussed in greater detail so as to avoid unnecessary complication of the description of the concepts, systems, circuits, devices, methods, and techniques described herein. For example, a person of ordinary skill in the art would recognize that connections between components (e.g., amplifiers, inductors, resistors, capacitors, switches, diodes, sources, subsystems) described herein may be realized with wires, circuit board traces on a printed circuit board (PCB) or any other way of electrically and/or mechanically connecting components together. A person of ordinary skill in the art will further understand that connection may mean an electrical connection, a mechanical connection or both an electrical and mechanical connection.

A person of ordinary skill in the art would further understand what is meant when discussing certain circuit components or subsystems herein, such as an impedance element (e.g., lumped element impedance or distributed element impedance, such as inductors, resistors, and/or capacitors), inductors, resistors, capacitors, switches, amplifiers, filters, linear regulators, switched-capacitor converters, supply modulators, and energy sources. For example, a switch may be implemented as a metal oxide semiconductor field effect transistor (MOSFET (e.g., N-channel MOSFET (NMOS), P-channel MOSFET (PMOS)), bipolar junction transistor (BJT), silicon-controlled rectifier (SCR), insulated gate bipolar transistor (IGBT), diode, integrated transistor switch (or integrated circuit (IC) transistor), or any other component known by one skilled in the art to provide a switching function in electronics. A person of ordinary skill in the art would recognize how to drive (i.e., provide bias and/or control signals to) these components to switch between an “on” state in which current flows through the component and an “off” state in which current does not flow through the component. A person of ordinary skill in the art would understand that these circuit components have terminals for connection to wires or circuit board traces. Thus, the description below and/or the claims may make reference to one or more terminals of a component to convey how that component is connected in relation to other components of the circuit. The term “energy storage element” as used herein should be considered to include any type of energy storage element (such as a capacitor or an inductor as just two examples).

A person of ordinary skill in the art would further recognize that electrical components may be imperfect and may fail at certain levels of current and/or voltage. As a result, components may be provided with ratings (e.g., a voltage rating or a current rating of the component) indicating a maximum level of electric current or voltage a component is designed to withstand, and beyond which the component might fail. A person of ordinary skill in the art would also understand that losses may occur in circuit components and connections. As a result, a person of skill in the art would recognize that, when discussing voltages and currents herein, those voltages and currents may be approximate, and in practice may be off by some degree from the described value (e.g., 1%-30% off from a described or target or ideal value).

The concepts, systems, circuits, devices, methods, and techniques described herein relate to power management and conversion. A person of ordinary skill in the art would understand certain concepts related to this topic. For example, a person of ordinary skill in the art would understand what is meant when describing certain types of power converters, such as a linear regulator or switched-mode power supply (SMPS). A person of ordinary skill in the art would further understand what is meant when describing certain types of SMPS power converters, such as buck converters, boost converters, buck-boost converters, or flyback converters. A person of ordinary skill in the art would further understand what is meant when describing a switched-capacitor converter. A person of ordinary skill in the art would understand that one or more switches of a power supply (e.g., SMPS) are typically operated by a controller at a certain operating frequency (e.g., kHz to MHz range). A person of ordinary skill in the art would understand that these converters typically operate in two distinct phases per cycle of their operating frequency, a first phase in which one or more switches may be on, and a second phase in which the one or more switches may be off. Output voltage or current may be controlled by changing the period for which the one or more switches are on or off per cycle. The percentage of on time per cycle may be referred to as a duty cycle.

A person of ordinary skill in the art would recognize that controllers in converters may receive feedback signals regarding one or more characteristics of the converter, and may modify one or more aspects of the converter accordingly, to achieve a desired output.

An energy source, as used herein, may be any type of energy source that provides a direct current (DC) voltage. For example, an energy source may be any type of battery, one example of which is a lithium-ion battery. An energy source may also be a DC source converted from an alternating current (AC) source, such as a DC source created by rectifying an AC source. A person of ordinary skill in the art would recognize that a system (e.g., power converter, supply generator and supply modulator system) may have input terminals configured for connection to terminals (e.g., opposing terminals) of the energy source to draw power from the energy source. A person of ordinary skill in the art would also recognize that a system (e.g., power converter, supply generator and supply modulator system) may have output terminals configured to be coupled to a load (e.g., power amplifier). A person of ordinary skill in the art would recognize that certain energy sources may have a voltage that varies, while other energy sources may have a voltage that is fixed. For example, a voltage supplied by a battery may vary over time as the battery discharges. In the case of a battery, chemical reactions within the battery may deplete the energy stored in the battery, thereby causing a decrease in voltage over time until the stored energy of the battery is such that it may no longer effectively power a device until it is recharged. By contrast, a DC source converted from an AC wall outlet, for example, may have a voltage that is fixed and that does not discharge over time.

A “regulator,” as used herein, may comprise one or more electrical components that may operate to provide a desired output voltage regardless of changes to an input voltage. A “supply generator,” as used herein, may comprise one or more electrical components that may operate to generate one or more output voltages from an input voltage. A “supply modulator,” as used herein, may comprise one or more electrical components that may operate to select between different voltage levels. For example, a supply modulator used in power supply circuitry to supply a voltage to a PA of a mobile device (e.g., mobile phone) as described herein may switch between different voltages at high frequency to efficiently adjust power supply voltage to a PA dynamically over time depending upon an RF signal being synthesized.

Power management and conversion techniques are described herein with respect to mobile applications, such as for use in mobile devices (e.g., mobile phones). However, the disclosure is not so limited. The techniques described herein may be applicable to any type of electronic device that uses power (e.g., mobile devices, laptops, tablets, personal computers, servers, televisions, base stations, and wearable devices such as watches, glasses, rings, bracelets, arm bands, chest bands, clothing items, etc.).

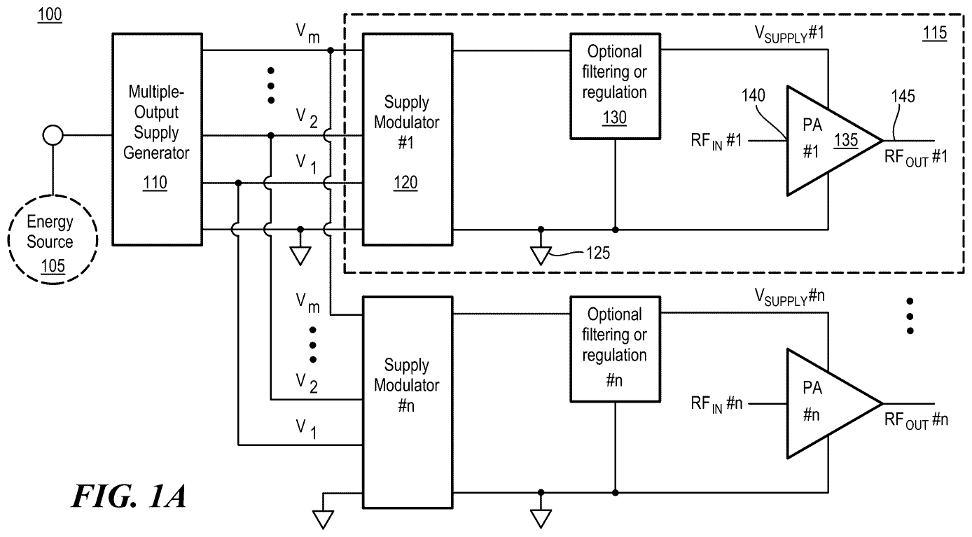

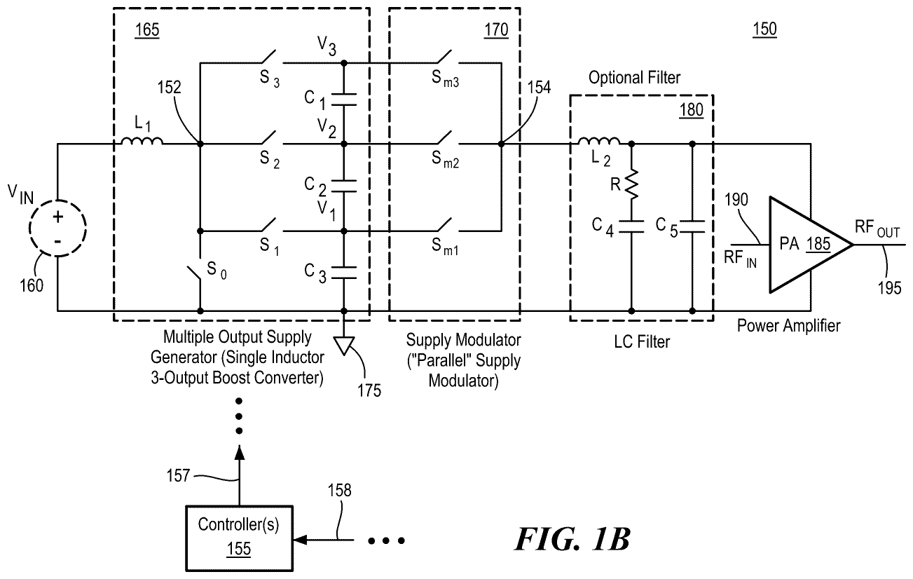

FIG. 1A shows an example of a radio frequency (RF) power amplifier (PA) system utilizing multiple supply levels, and supply modulators to select from the multiple supply levels. Elements and aspects related to signal processing and control for such a system are omitted from FIG. 1A for clarity. System 100 may utilize supply modulation for providing power to one or more RF power amplifiers 135 (e.g., as may be used in a mobile device). System 100 may include a supply generator 110 having an input configured to be coupled to an energy source 105, such as a battery (energy source 105 is here shown in phantom since it may not properly be part of system 100). Supply generator 110 may receive an input signal (e.g., an input voltage) from energy source 105 and in response thereto may output different voltage levels (e.g., 0V, V₁, V₂, . . . , Vₘ) on different voltage rails (e.g., connections, or signal paths each having a certain voltage-such as 0V, V₁, V₂, . . . , Vₘ as illustrated in FIG. 1A). That is, a supply generator subsystem (or more simply a “supply generator”) (e.g., supply generator 110) of system 100 may be a multiple output supply generator 110 that may synthesize multiple power supply voltages V₁-Vₘ from a single input energy source 105. In some examples, a supply generator (e.g., supply generator 110) may regulate one or more of power supply voltages V₁-Vₘ.

System 100 may further include a subsystem 115, which may include a supply modulator 120, optional filtering or regulation circuit 130, and/or power amplifier 135, all of which may be connected to the different voltage rails. For example, supply modulator 120 (e.g., supply modulator #1) may be connected to the voltage rails and may be configured to switch among the multiple voltages of the voltage rails. That is, a supply generator (e.g., supply generator 110) may provide one or more of the voltages V₁-Vₘ to inputs of one or more supply modulator subsystems (or more simply “supply modulators”) (e.g., supply modulator #1 120, supply modulator #n) of a supply modulator subsystem (e.g., subsystem comprising supply modulator #1, . . . , supply modulator #n).

The supply modulators (e.g., supply modulator #1, . . . , supply modulator #n) may switch (e.g., rapidly switch) among the different power supply voltages provided thereto by the supply generator (e.g., supply generator 110) to provide modulated supply voltages V_{SUPPLY} #1-V_{SUPPLY} #n at an output thereof. In some embodiments, switches may be modulated sufficiently rapidly to provide a power supply voltage to the PA such that the PA may provide the required RF output envelope while maintaining high efficiency, in accordance with techniques such as discrete drain modulation, envelope tracking advanced (ETA), discrete envelope tracking, and digital envelope tracking (digital ET). Such techniques are described, for example, in one or more of U.S. Pat. Nos. 8,829,993; 9,160,287; 9,172,336; 9,209,758; and 9,755,672, each of which is commonly assigned and is hereby incorporated by reference herein in its entirety. The supply voltages may be coupled to supply terminals of respective ones of one or more PAs (e.g., PA #1 135-PA #n). In some examples, PA #1 135-PA #n may be provided as RF power amplifiers. In some examples, a supply generator (e.g., supply generator 110) may supply the same or different voltages to different supply modulators (e.g., supply modulator 120-supply modulator #n). In some examples, a different number of voltages may be coupled between a supply generator (e.g., supply generator 110) and different supply modulators (e.g., supply modulator #1 120-supply modulator #n).

A filtering or regulation circuit 130 may optionally be connected to supply modulator 120 to filter or regulate the voltage signal selected by supply modulator 120. The result may be a voltage supply (e.g., V_{SUPPLY} #1) for powering a power amplifier (PA) 135 (e.g., PA #1). Power amplifier 135 may amplify an RF input signal 140 (e.g., RF_{IN} #1), and the amplified RF signal may be output as RF output signal 145 (e.g., RF_{OUT} #1). RF input signal 140 may be, for example, an RF signal to be amplified in a mobile device for wireless transmission as RF output signal 145 (e.g., as a cellular or WiFi signal). As shown in FIG. 1A, some or all of the supply voltages may be coupled to the supply terminals of the PAs through respective ones of optional filtering and/or voltage regulation stages (e.g., optional filtering or regulation circuit 130). The filtering and/or voltage regulation stages may comprise filtering networks, such as passive filters, active filters, and/or additional circuitry capable of regulating the voltage (e.g., including low-dropout regulator(s) (LDOs)) to the PA, V_{SUPPLY}, from a modulated voltage, V_{MOD}.

In some examples, one, some, or all of the supply modulators (e.g., supply modulator #1-supply modulator #n) in system 100 may comprise one or more switches to couple one or more voltages provided by a supply generator (e.g., supply generator 110) to PA supply terminals (as V_{SUPPLY} #1-V_{SUPPLY} #n, respectively). A variety of different switching circuits (e.g., circuits having switches arranged in any of a variety of different switch configurations or switch topologies) may be utilized to realize any of the supply modulator subsystems (e.g., supply modulator #1-supply modulator #n). For example, a supply modulator subsystem may comprise a plurality of switches connected in a ladder fashion and configured to provide a “series” modulator. Alternatively, a supply modulator subsystem may comprise a plurality of parallel coupled switches configured to provide a “parallel” modulator. Alternatively still, a supply modulator subsystem may comprise various couplings of switches intended to provide selective conductive paths from a set of supplies to an output.

As shown in FIG. 1A, system 100 may include any number of subsystems connected to the voltage rails, and connected with their inputs in parallel with each other. For example, system 100 may include any number of supply modulators (e.g., supply modulator #1, . . . , supply modulator #n), optional filtering or regulation circuits (e.g., optional filtering or regulation circuit 130), and power amplifiers (e.g., power amplifiers PA #1, . . . , PA #n). A ground rail 125 may also be connected to various components in system 100. Given the example topology of system 100, the multiple subsystems may supply from the same energy source (e.g., energy source 105) and supply generator (e.g., supply generator 110), different powers (e.g., V_{SUPPLY} #1, . . . , V_{SUPPLY} #n) to any number of power amplifiers (e.g., PA #1, . . . , PA #n) based on each power amplifier's supply needs.

Although FIG. 1A illustrates system 100 as having one supply generator supporting multiple power amplifiers, and one supply modulator and optional filtering or regulation circuit for each power amplifier, the disclosure is not so limited. A person of ordinary skill in the art would recognize, for example, that multiple supply generators may be used to generate any number of voltage rails, and that a single supply modulator and/or filtering or regulation circuit may be used to provide a supply voltage to multiple power amplifiers.

It is to be appreciated that the manner in which the voltages are synthesized by a supply generator (e.g., supply generator 110) of system 100 may affect the required ratings of the switches in the one or more supply modulators (e.g., supply modulator #1-supply modulator #n) of system 100. This may be a consideration in designing a system 100, as the required voltage ratings of the modulator switches may influence (and in some cases, highly influence) switching speed (and therefore achievable modulation rate) and modulator efficiency, both of which may be significant factors in a system. Regardless of the modulator switch topology used, if there are for example an m number of supply levels ordered in increasing voltage V₁, . . . , Vₘ (i.e., V₁<V₂< . . . <Vₘ), then it may be desired that the plurality (or chain) of switches coupled between the j^{th} supply voltage Vⱼ and the supply modulator output voltage V_{MOD} be rated to block at least a negative voltage of a magnitude (Vₘ-Vⱼ) and a positive voltage that is either (Vⱼ-V₁) or Vⱼ depending upon whether the modulator sources a lowest voltage V₁ or in some cases is able to directly supply a voltage of zero volts (0V) to the PA. In some example systems having designs of the latter type (where the modulator may supply a voltage of 0V), where the power supply provided to the PA may need to be “cut off” (discharged to a zero volt power supply), a separate low-frequency “turn-off” or “disconnect” switch may be placed in series with the output of a supply modulator capable of sourcing modulator output voltages V₁, . . . , Vₘ. Such a turn-off switch may reduce the modulator switch chain voltage blocking requirements from Vⱼ to (Vⱼ-V₁).

In some examples, an RF power amplifier system, such as system 100, may comprise a “series” modulator in a form suitable for integrated circuit (IC) fabrication and for use with ratiometric supply voltages (e.g., V₂=2V₁, V₃=3V₁, V₄=4V₁). Such a design illustrates the impact of the supply levels on the required voltage rating of individual modulator devices. By correct selection of the level voltages, an advantageous use of integrated complimentary metal-oxide semiconductor (CMOS) processes may be made using core devices and/or extended voltage devices to achieve the required voltage blocking characteristics of the modulator switch chains. Moreover, such a circuit illustrates the use of the generated levels for gate drive of the devices. This type of drive circuit facilitates high efficiency and switching speed. However, to take advantage of driving device gates between adjacent level voltages (e.g., between Vⱼ and Vⱼ₋₁), level voltages for this design should be maintained with sufficient spacing. Otherwise, more sophisticated gate drive circuit designs may be required, which may limit achievable switching performance.

FIG. 1B shows another example system 150 that may utilize supply modulation for providing power to a PA 185 of an RF system. System 150 of FIG. 1B may include an energy source 160, supply generator 165, supply modulator 170, optional filter 180, and PA 185. For example, supply generator 165 may be implemented with a boost converter circuit (e.g., single inductor 3-output boost converter) that includes a single inductor (e.g., L₁), three capacitors (e.g., C₁, C₂, C₃), and four switches (e.g., S₀, S₁, S₂, S₃). The single inductor (e.g., L₁) may have a first terminal coupled to an energy source (e.g., voltage supply) 160 and a second terminal coupled to a node 152. Supply modulator 170 may be implemented with 3 switches (e.g., Sₘ₁, Sₘ₂, Sₘ₃) with one terminal of each switch connected in common at node 154. A second terminal of each of the switches may be coupled to a respective voltage node established via capacitor stack C₁, C₂, C₃ (e.g., a plurality of capacitors C₁, C₂, C₃ serially coupled between a first voltage node and ground so as to establish a plurality of voltage nodes V₁-V₃). A fourth switch (e.g., S₀) may have a first terminal coupled to node 152 and a second terminal coupled to ground. In the example of FIG. 1B, the second terminal of switches S₁, S₂, S₃ are coupled to respective ones of voltage nodes V₁, V₂, V₃.

In the example of FIG. 1B, node 154 is coupled to a supply terminal of a PA 185 through an optional filter circuit 180. Optional filter circuit 180 may be implemented as an LC (inductor, capacitor) filter with an inductor (e.g., L₂) connected in series with the supply input to PA 185, a resistor (e.g., R), and capacitor (e.g., C₄) connected in series with one another, and in parallel with PA 185, and a capacitor (e.g., C₅) connected in parallel with PA 185. In some embodiments, optional filter circuit 180 may comprise an impedance, such as a resistor, capacitor, or inductor. In some embodiments, the impedance may comprise at least one of a lumped element or a distributed element. In some embodiments, node 154 may be coupled to the supply terminal of PA 185 through other circuitry (e.g., circuitry other than or in addition to filter circuitry). In still other examples, node 154 may be directly coupled to the supply terminal of PA 185.

A ground rail 175 may be connected to various components in system 150. PA 185 may amplify an input RF signal 190 (e.g., RF_{IN}) and output the amplified RF signal as an output RF signal 195 (e.g., RF_{OUT}). Although FIG. 1B illustrates an example implementation of a system 150, the disclosure is not so limited. A person of skill in the art would recognize that there are additional ways to construct a supply generator 165, supply modulator 170, and filter circuit 180.

In some examples, the circuitry illustrated for system 150 may be used to implement at least portions of system 100 of FIG. 1A. For example, supply generator 165 of FIG. 1B may be used as supply generator 110, supply modulator 170 may be used as supply modulator 120, and optional filter 180 may be used as optional filtering or regulation circuit 130.

The systems illustrated in FIGS. 1A, 1B include two separate subsystems: (a) a supply generator that may synthesize multiple power supply voltages from a single input source, and possibly regulate one or more of those power supply voltages, and (b) one or more supply modulators that may each rapidly switch among the power supply voltages provided by the supply generator to provide a modulate supply voltage to a PA. The systems illustrated in FIGS. 1A and 1B are examples of systems that may be especially suitable for discrete supply modulation.

The manner in which these two subsystems are best implemented (or “realized”) may depend upon the power level, voltage level, and application space of the RF amplifier system. For many mobile applications (e.g., cell phones, smart phones, personal devices, and the like), it may be desirable to monolithically integrate electronic elements of both the supply generator and supply modulator on a single semiconductor die (e.g., in a CMOS process or a BCD (Bipolar-CMOS-DMOS) process). In some cases, it may be desirable to integrate electronics for the supply generator, supply modulator(s), and PAs on a single die. In other cases (e.g., at high power) it may be desirable to implement the subsystems with discrete components connected on or more printed circuit boards (PCBs).

A system (e.g., system 100 of FIG. 1A, system 150 of FIG. 1B) may include control and/or signal processing aspects not shown in FIG. 1A or 1B. For example, a change in RF PA supply voltage may typically cause a change in the RF PA gain and insertion phase, and perhaps also its memory effect characteristics. Therefore, it may be important that supply modulation (e.g., changes in PA supply voltage) be carefully coordinated with a digital pre-distortion (DPD) controller. Algorithms in a DPD controller may predict the non-idealities that may be imposed on the modulated RF signal by the RF PA, and may apply the inverse of these non-idealities. As a result, the inverse of a non-ideality may be passed through the PA (which also applies the non-ideality), resulting in an ideal or substantially ideal linear signal. Gain phase, memory, and/or other non-idealities may be compensated using DPD algorithms.

One or more controllers 155 may also operate to control switches in system 100 and/or system 150. For example, a person of skill in the art would recognize that one or more controllers may be used to control the on/off states and on/off timing of switches S₀-S₃ and/or Sₘ₁-Sₘ₃ via one or more signal lines (e.g., circuit connections) 157, for example, at high frequency. A person of skill in the art would recognize that, although only one signal line 157 is shown in FIG. 1B, system 150 may include a separate line from controller(s) 155 for each switch in system 150, to control each of the switches individually. Alternatively, some of the switches in system 150 may be controlled together with a single signal line, while others may be controlled individually with separate signal lines.

Controller(s) 155 may be used to switch on/off states and timing of switches S₀-S₃ so as to charge 3 different capacitors C₁-C₃ to three different voltages V₃-V₁, respectively. Controller(s) 155 may also be used to control on/off states and timing of switches Sₘ₁-Sₘ₃ to select from voltages V₁, V₂, V₃, respectively, for providing a selected voltage to optional filter 180 or PA 185. A person of ordinary skill in the art would appreciate that controller(s) 155 may receive one or more input signals 158, such as feedback or feedforward signals, via one or more signal lines, for use in determining how to control switches S₀-S₃ and Sₘ₁-Sₘ₃. For example, controller(s) 155 may be connected to V_{SUPPLY} to monitor the voltage at V_{SUPPLY} or the current being supplied to PA 185, and may change on/off states and/or timing of switches S₀-S₃ and/or Sₘ₁-Sₘ₃ to ensure a desired voltage or current is output. As another example, controller(s) 155 may monitor an RF signal amplitude of an RF signal (e.g., RF_{IN} 190) and adjust on/off states and/or timing of switches S₀-S₃ and/or Sₘ₁-Sₘ₃ to adjust a supply voltage or current to PA 185 based on the RF signal amplitude. A person of skill in the art would recognize that any number of signals (e.g., input voltage V_{IN}, current drawn from energy source I_{IN}, inductor current (i_{L1} and/or i_{L2}), voltages (V₁, V₂, V₃, and/or V_{SUPPLY}), current to PA 185) within system 150 may be monitored by controller(s) 155, and that controller(s) 155 may control the switches of system 150 based on these signals. In some embodiments, controller(s) 155 may comprise a feedforward current shaping controller.

A person of ordinary skill in the art would further recognize that controller(s) 155 may include circuitry and/or subsystems. For example, controller(s) 155 may have internal components, such as resistors, capacitors, inductors, diodes, comparators, oscillators, clocks, digital logic components (e.g., latches, flip flops), and/or amplifiers, for use in controlling a frequency of operation of a converter and making determinations about how to control a system (e.g., system 150) based on feedback/feedforward signal(s) 158. Controller(s) 155 may also include a voltage regulator or other power supply circuitry for powering controller(s) 155. Controller(s) 155 may further include protection subsystems, such as voltage or current protection subsystems. These subsystems may, for example, prevent over voltage or under voltage conditions from occurring or over current or under current conditions from occurring, such as by sensing a voltage or current is exceeding a predetermined value and by, for example, shutting the converter circuit down temporarily or otherwise mitigating such a condition in order to prevent destruction of components in the circuit.

In some embodiments, controller(s) 155 may include a processor and memory. The memory may be programmed with instructions, such that the processor, when executing the instructions, controls the switches of a system (e.g., system 150) based on received feedback/feedforward signal(s) 158. In some embodiments, the components and/or subsystem of controller(s) 155 may be packaged together, such that controller(s) 155 is an integrated circuit (IC) containing these components/subsystems, for example.

Although not shown, controller(s) 155 may further receive an input command signal. For example, controller(s) 155 may be configured to receive commands from a user or other device that programs controller(s) 155 to perform certain functions, or to otherwise change the functioning of controller(s) 155. For example, controller(s) 155 may receive digital commands, such as digital control level (DCL) commands, over a digital interface (e.g., DCL interface) from one or more other controllers for instructing controller(s) 155 on how to control switches of a system or for otherwise changing the functioning of controller(s) 155. Example techniques involving DCL commands are described in U.S. Pat. No. 12,069,580, titled “Power Management Control Over Transmission Line For Millimeter Wave Chip Sets for Cellular Radios,” which is commonly assigned and is hereby incorporated by reference herein in its entirety.

A person of ordinary skill in the art would further recognize that subsystems within controller(s) 155 may themselves have circuitry. For example, subsystems within controller(s) 155 may have internal components, such as resistors, capacitors, inductors, diodes, comparators, oscillators, clocks, digital logic components (e.g., latches, flip flops), and/or amplifiers, for use in controlling a frequency of operation of a converter circuit and making determinations about how to control a system (e.g., system 150) based on feedback/feedforward signal(s) 158. In some embodiments, a subsystem may itself include a processor and memory. The memory may be programmed with instructions, such that the processor, when executing the instructions, can output signals and/or commands based on certain input signals being received by the subsystem.

In some embodiments, one or more controllers may be used to operate some of the switches in a system (e.g., system 150), while one or more other controllers may be used to operate other switches in the system. For example, a first set of one or more controllers 155 may operate to control on/off states and on/off timing of switches S₀-S₃ via a first set of one or more signal lines (e.g., circuit connections) 157, thereby controlling supply generator 165. A second set of one or more controllers 155 may operate to control on/off states and on/off timing of switches Sₘ₁-Sₘ₃ via a second set of one or more signal lines (e.g., circuit connections) 157, thereby controlling supply modulator 170. In some embodiments, the first set of one or more controllers 155 may operate switches S₀-S₃ at a different frequency and/or duty cycle than the frequency and/or duty cycle at which the second set of one or more controllers 155 may operate switches Sₘ₁-Sₘ₃. In some embodiments, a first set of one or more controllers 155 may receive a first set of one or more feedback/feedforward signals 158 and a second set of one or more controllers 155 may receive a second set of feedback/feedforward signals 158 that may be different than the first set of feedback/feedforward signals 158.

In some embodiments, one or more controllers 155 may be implemented on the same die as one or more supply generators (e.g., supply generator 165), one or more supply modulators (e.g., supply modulator 170), one or more filters (e.g., filter 180), and/or one or more PAs (e.g., PA 185). In other cases, it may be desirable to implement one or more controllers 155 as a discrete component connected on one or more PCBs.

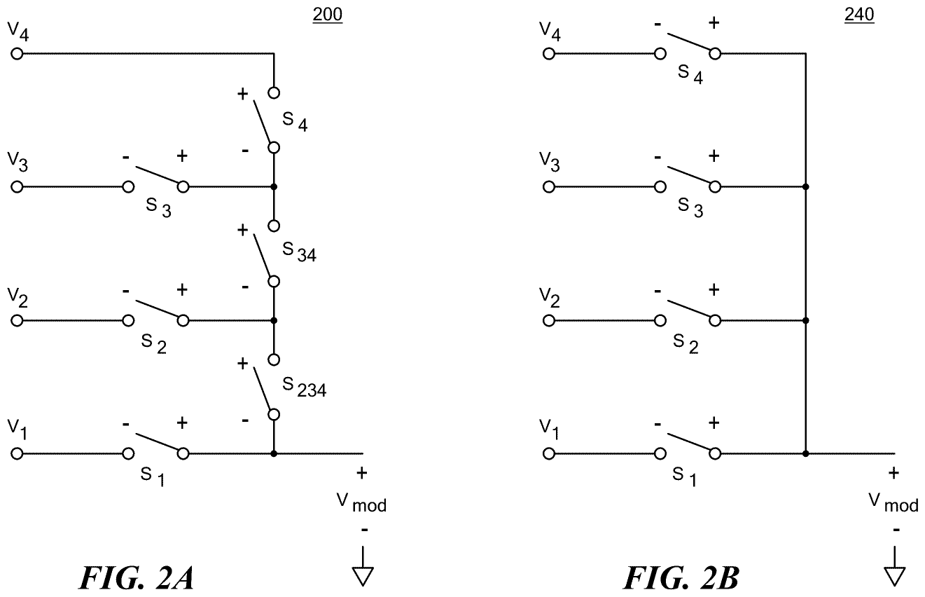

A variety of different switching circuits may be utilized to implement/realize a supply modulator subsystem. Two illustrative networks are shown in FIGS. 2A, 2B. FIG. 2A illustrates an example series modulator 200 having switches S₁-S₄, S₃₄, and S₂₃₄, connected as shown. FIG. 2B illustrates an example parallel modulator 240 having switches S₁-S₄ connected as shown. Additionally, filtering networks, including passive filters and/or active filters and/or additional circuits for regulating a voltage (e.g., including low-dropout regulator(s) (LDOs)) to the PA (e.g., V_{SUPPLY}) from the modulated voltage (e.g., V_{MOD}) may be utilized, as illustrated in FIGS. 1A, 1B.

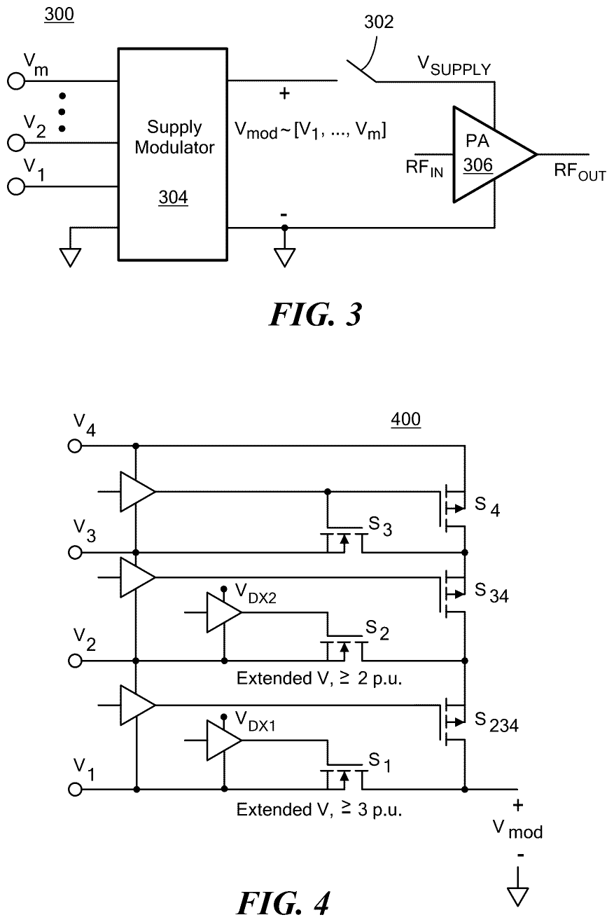

Referring now to FIG. 3, in some embodiments, the modulated power supply provided to the PA (e.g., V_{SUPPLY}) may need to be “cut off” (e.g., discharged to a zero volt level). For example, this may be used to enable reduction of the modulator switch voltage ratings in cases when a zero output must be provided to the PA. In such cases, a circuit 300 may include a separate low-frequency turn-off switch 302 (or “disconnect switch”) coupled in series between an output of a supply modulator 304 (capable of sourcing modulator output voltages V₁, . . . , Vₘ) and a PA 306.

FIG. 4 shows an example implementation of the series modulator of FIG. 2A, in a form suitable for integrated circuit (IC) fabrication and for use with ratiometric supply voltages (e.g., V₂=2V₁, V₃=3V₁, V₄=4V₁). An illustrative circuit 400 includes switches S₁, S₂, and S₃ implemented as N-channel MOS (NMOS) transistors and switches S₄, S₃₄, and S₂₃₄ implemented as P-channel MOS (PMOS) transistors. Circuit 400 also includes CMOS gate drivers powered differentially among levels.

Circuit 400 illustrates the impact of the supply levels on the required voltage rating of individual modulator devices. By correct selection of the level voltages, an advantageous use of integrated CMOS processes may be made using core devices and/or extended voltage devices to achieve the required voltage blocking characteristics of the modulator switch chains. Moreover, circuit 400 illustrates the use of the generated levels for gate drive of devices (e.g., transistors). This type of drive circuit approach may facilitate high efficiency and switching speed. The possibility of incorporating NMOS-type devices may bring additional advantages of smaller size and improved performance, provided the gate drive requirements may be accommodated.

To take advantage of driving the device gates between adjacent level voltages (e.g., between Vⱼ and Vⱼ₋₁), level voltages for this design should be maintained with sufficient spacing. Otherwise, more sophisticated gate drive designs may be required, which may limit achievable switching performance. Systems, methods, circuits, devices, and techniques described herein facilitate maintaining voltage levels that are suitable for achieving integrated circuit-based modulators and high-performance gate drive circuits through the ability to maintain desired voltage relationships among the levels.

Supply generators may be realized through a variety of methods. For example, supply generators may be realized using multiple separate converters, multiple-output magnetic converters, multiple-output switched-capacitor converters, and hybrid magnetic/switched-capacitor converters, including those providing a ratiometric set of output voltages. A further approach is to realize a multiple-output supply generator that creates two independently controllable direct current (DC) voltages (e.g., with a magnetic conversion stage) and further uses a differential capacitive energy transfer stage to realize one or more further DC supply voltages that are ratiometrically distributed between or around the two independently controllable voltages. Each of these approaches may have limitations in terms of achievable size, cost, efficiency, and/or performance (e.g., modulation bandwidth) of supply-modulated RF amplifier systems.

Use of multiple separate power converters to generate multiple supply voltages may yield a solution that is flexible, allowing each output voltage to be independently regulated to desired values independent of input voltage variations and providing the ability to continuously adjust the output voltages over time (e.g., to provide for adaptive bias of the PA). Unfortunately, this solution may be inherently large and expensive, owing to the large numbers of physically large power supply components (e.g., magnetic components) required.

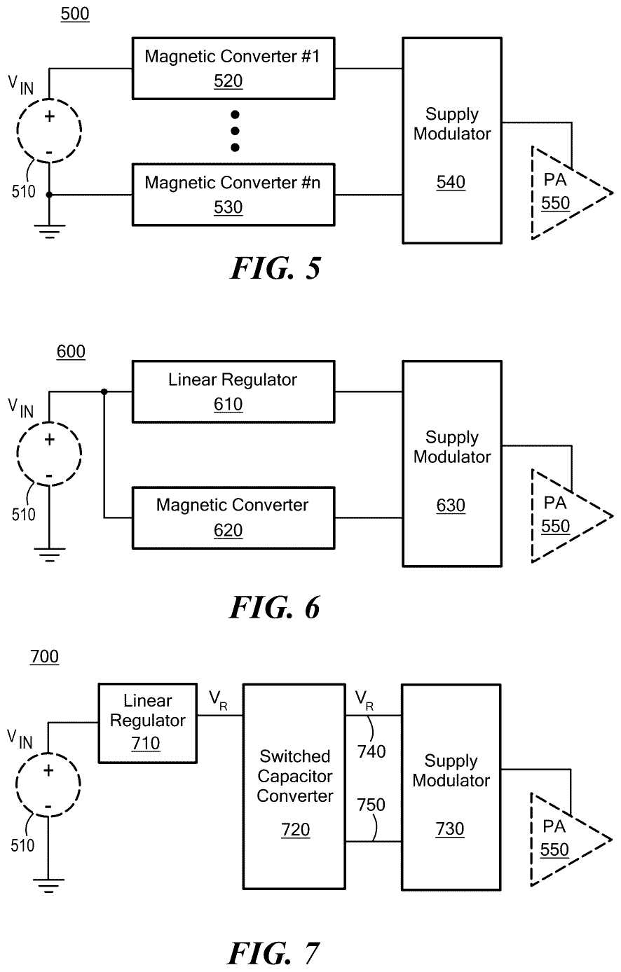

FIG. 5 is a diagram of an example system 500 utilizing multiple separate magnetic power converters (e.g., magnetic converter #1 520, . . . , magnetic converter #n 530). Components of the separate magnetic power converters, or the duty cycle and/or frequency at which the two separate magnetic power converters are operated, may differ such that the multiple magnetic power converters output different voltages. Use of multiple separate magnetic power converters may allow a system to provide a variety of different output voltages to a supply modulator 540. For example, one or more of the multiple magnetic power converters may be buck converters, boost converters, buck-boost converters, flyback converters, or any other known type of magnetic power converter. As one example, system 500 may comprise two magnetic power converters, a magnetic converter #1 520 configured as a buck converter, and a magnetic converter #n 530 configured as another buck converter. Each of the buck converters may be configured to receive a voltage from an energy source 510 (e.g., battery). If, for example, energy source 510 provides a voltage of 3.8V, one buck converter (e.g., magnetic converter #1 520) may be configured to output a voltage of 3.3V, and the other buck converter (e.g., magnetic converter #n 530) may be configured to output a voltage of 2.3V. Supply modulator 540 may select between the two voltages, such that a voltage supply between 3.3V and 2.3V may be provided to PA 550. Such a system using magnetic power converters may have high efficiency, but may have higher cost and require more size than other approaches, given the higher cost and size of the magnetic components. Energy source 510 and PA 550 are illustrated in phantom in FIG. 5, as one or both of them may not properly be considered to be part of system 500 (e.g., system 500 may not include, but be configured to connect with, these elements). It will be appreciated that a switched-capacitor converter with its inputs connected differentially between two such magnetic converters and its output(s) connected to the supply modulator (not shown) may provide a means to provide additional voltages to the supply modulator.

FIG. 6 is a diagram of an example system 600 utilizing one or more magnetic power converters (e.g., magnetic converter 620) and one or more linear regulators (e.g., linear regulator 610). Use of a combination of one or more magnetic power converters and one or more linear regulators may allow a system to provide a variety of different output voltages to a supply modulator 630. A linear regulator (e.g., linear regulator 610) may, for example, be a low dropout (LDO) regulator. A linear regulator may receive an input voltage (e.g., V_{IN}) and may output an output voltage (e.g., V_{R}) lower than the input voltage. As is known, a linear regulator may include one or more transistors (e.g., metal oxide semiconductor (MOS transistors), such that the bias of the transistor(s) may be adjusted by one or more controllers (e.g., controller(s) 155) to cause a voltage drop within the linear regulator and to thereby output a desired output voltage lower than the input voltage. That is, one or more transistors within the linear regulator may operate similar to resistors, except that the resistance (and associated dissipative loss/voltage drop) of the linear regulator may be adjusted by adjusting the bias of the transistor(s). In some embodiments, the output voltage of the linear regulator may be set by an output reference voltage. In some embodiments, this output reference voltage may be selected from among multiple discrete regulation points (e.g., a feedback signal for the controller controlling the linear regulator may be sensed at different nodes in the system). A person of ordinary skill in the art would recognize that a variety of different types of linear regulators are known, and any of these known types should be considered to be within the scope of the disclosure herein.

The one or more linear regulators (e.g., linear regulator 610) of system 600 and the one or more magnetic converters (e.g., magnetic converter 620) of system 600 may be operated separately so as to output different voltages. As one example, if energy source 510 (e.g., battery) provides a voltage of 3.8V, linear regulator 610 may be configured to provide an output voltage of 3.3V and magnetic converter 620 (e.g., buck converter) may be configured to output a voltage of 2.3V. Supply modulator 630 may select between the two voltages, such that a voltage supply between 3.3V and 2.3V may be provided to PA 550. Such a system using a combination of one or more linear regulators (e.g., linear regulator 610) and one or more magnetic converters (e.g., magnetic converter 620) may be less efficient (e.g., as power is dissipated by the linear regulator(s)) than example system 500 of FIG. 5, but may be smaller in size and less expensive (e.g., due to the smaller size and lower cost of a linear regulator as compared to an inductor). It will be appreciated that a switched-capacitor converter with its inputs connected differentially between linear regulator 610 and magnetic converter 620 and its output(s) connected to the supply modulator (not shown) may provide a means to provide additional voltage(s) to the supply modulator at small size and high efficiency.

Single-input multiple-output converters (sometimes referred to as “SIMO” converters) may allow multiple output voltages to be independently regulated while only requiring a single magnetic component, somewhat mitigating the size challenge of multiple power converters. However, SIMO designs may inherently utilize time-sharing of the inductor to supply the multiple outputs, and therefore performance and efficiency may degrade and control complexity may increase with increasing numbers of outputs. This characteristic may limit the efficacy of this approach in multilevel supply modulator systems, which typically utilize between three and seven supply levels to achieve high performance (with even more levels potentially desirable in some cases).

Some types of converters, such as conventional multiple-output magnetic converters (e.g., multi-output flyback converters), multiple-output switched-capacitor converters and hybrid magnetic/switched-capacitor converters may yield multiple ratiometrically related output voltages while reducing the numbers of magnetic components required as compared to using multiple independent power converters. Traditional multiple-output magnetic converters typically utilize transformers with scaled turns ratios to generate multiple ratiometrically scaled output voltages. These designs may only regulate a single output, with the ratiometric relations of the other outputs approximately maintained by the transformer turns ratios (unless additional “post regulation” is provided to the other outputs, such as through use of added linear regulators). The use of transformers tends to lower achievable efficiency in these designs (sometimes to unacceptable levels), and such designs may suffer significant cross regulation among the outputs in practice (i.e., one output voltage varying depending upon the load on a different output). This may result in undesirable performance in RF amplifier system unless additional post regulation is used, which may further degrade performance.

Multiple-output switched-capacitor converter circuits may generate multiple ratiometrically related output voltages while achieving very high efficiency and small size, with the rational (ideal) ratios among output voltages determined by the circuit topology and/or switching pattern. However, with this type of circuit, the output voltages are all scaled versions of the input voltage, which does not provide a way to continuously regulate the output voltages independent of variations in the input voltage.

Some possible limitations of these previous approaches to multiple-output supply generation may be addressed via hybrid magnetic/switched-capacitor circuits having ratiometrically scaled outputs. In these designs, a magnetic regulation stage may independently regulate a single output voltage (independent of the system input voltage) with additional ratiometrically-related output voltages synthesized and enforced through action of a switched-capacitor voltage balancer stage. For example, in an m-output supply generator, the magnetic stage may take an input voltage V_{X} and regulate a single output voltage V_{Y}, with the switched capacitor voltage action synthesizing (ideally) voltage k₁*V_{Y}, k₂*V_{Y}, . . . , kₘ₋₁*V_{Y}, where constants k₁, . . . , kₘ₋₁ are rational numbers that may be determined by the circuit topology and/or switching pattern. Advantages of this approach may include relatively high efficiency and small size requirements for synthesizing multiple related output voltages and relative simplicity of control.

Merits of the above design approaches notwithstanding, designs yielding ratiometric supply generator voltage outputs may have limitations for PA systems utilizing multiple level supply modulation.

One possible limitation of ratiometric outputs relates to the usable supply voltage ranges for available PAs. Some PAs may function well with wide supply voltage ranges of up to 4:1 or even larger (e.g., function well across a power supply voltage range from a maximum voltage of Vₘₐₓ down to a minimum voltage equal to or less than Vₘᵢₙ=Vₘₐₓ/4). Many other PAs—including those typically used in applications such as WiFi, mobile handset, and multiple input multiple output (MIMO) transmitters for Long Term Evolution (LTE) and 5G applications—may only operate over much narrower supply voltage ranges (e.g., 3:1 or even less). With ratiometric supply voltages, if the maximum voltage generated is reduced (e.g., for conditions of reduced average PA output power), then the synthesized ratiometric voltages for all may be reduced proportionally. This often means that one or more of the lowest synthesized voltages may become unusable for supply modulation under such conditions, as they may fall below the allowed minimum PA power supply voltage. This in turn may reduce the achievable PA efficiency enhancements that may be provided through supply modulation under these conditions. In many applications, it may be desirable if the power supply voltages were not maintained as a fixed set of ratios, such that all (or nearly all) of the synthesized supply voltage levels may remain above the allowed minimum voltage for the PA under reduced power operation.

Another possible limitation of ratiometric outputs relates to how the spacing between voltages may vary as the largest supply voltage synthesized is reduced. In a ratiometric-output supply generator, two adjacent voltages may be expressed as kⱼ*V_{Y} and kⱼ, where k is a scaling value, j is an integer index, V is a voltage, Y is an index corresponding to the number of voltage levels, V_{Y} is the Y^{th} voltage level, and where the value of V_{Y} may be scaled up or down as the average transmit power of the PA is adjusted. The difference between voltage levels may thus be expressed as (kⱼ−kⱼ₋₁)*V_{Y}, which may scale up and down proportional to V_{Y}. As described above with respect to FIG. 4, this may be problematic for driving integrated modulator switches, especially where the gate drive voltages are derived from interlevel voltages (i.e., voltage differences between levels). This may result in increased gate drive complexity in an integrated modulator, and may limit achievable switching performance of the modulator. In many applications, it may be desirable for the power supply voltages to not be maintained as a fixed set of ratios, such that the spacing between adjacent levels may be controlled independently of the maximum supply voltage synthesized.

### A Cascade Supply Generator and Supply Modulator

For PA architectures using supply modulation, it may be desirable to provide a system that provides both very rapid variations in modulated power supply voltage (e.g., among multiple discrete levels) while also providing the ability to slowly adapt the voltages of the discrete levels over a desired range and/or maintaining the discrete levels as the voltage of the input energy source varies.

In particular, and as previously discussed, it may be useful to be able to inexpensively, efficiently, and/or compactly generate a set of m discrete levels for supply to a PA. In some embodiments, one of the m discrete levels may be independently controllable, and the other m−1 voltage levels may be distributed in a prescribed relation to the one independently-controlled level. In some embodiments, two of the m voltage levels may be independently controllable and the other m−2 voltage levels distributed in a prescribed relation to the two independently-controlled levels.

While not quite as flexible as truly independent control of all voltages, one would gain most of the practical benefits available from supply modulation (e.g., in terms of PA efficiency) while avoiding the above-described possible limitations associated with providing truly independent voltage level control. Such a design may provide significant advantages in combinations of size, cost, efficiency, and performance as compared to existing approaches.

It may be further beneficial to provide one or more switched capacitor converters and one or more supply modulators in cascade. In some embodiments, switches of a switched capacitor converter may be controlled to generate a set of different output voltages. For example, switches of a switched capacitor converter may be controlled to generate a set of voltages (⅔)*V_{IN} and (⅓)*V_{IN}. As another example, switches of a switched capacitor converter may be controlled to generate a voltage (½)*V_{IN}. As one more example, switches of a switched capacitor converter may be controlled to generate a set of voltages (¾)*V_{IN} and (½)*V_{IN}.

It may still further be beneficial to provide one or more controllable linear regulators coupled to one or more switched capacitor converters and one or more supply modulators in cascade. Using a linear regulator in such a system may be advantageous in that linear regulators are small in size and relatively inexpensive. By providing both a controllable linear regulator and a controllable switched capacitor converter, the linear regulator may be controlled to supply a regulated voltage at a desired level, and the switched capacitor converter may be configured to generate a set of one or more voltages based on the regulated voltage V_{R}. The one or more regulators and one or more switched capacitor converters may together be referred to as a “supply generator” herein.

It may also be beneficial to provide one or more reconfigurable switched capacitor converters and one or more supply modulators in cascade. In some embodiments, switches of a reconfigurable switched capacitor converter may be controlled to provide different sets of different output voltages. For example, in one operating mode, switches of a switched capacitor converter may be controlled to generate a set of voltages (⅔)*V_{IN} and (⅓)*V_{IN}. In another operating mode, switches of the switched capacitor converter may be controlled to generate a voltage (½)*V_{IN}. Providing for such switching between different operating modes to generate different sets of output voltages may be beneficial in applications where a voltage level of an energy source (e.g., battery) may vary over time (e.g., as a battery discharges/recharges), for example.

It may further be beneficial to provide one or more controllable linear regulators coupled to one or more reconfigurable switched capacitor converters and one or more supply modulators in cascade. Using such a system may improve flexibility in selecting voltages to output to a supply modulator, as both the output voltage V_{R} of the linear regulator and the set of output voltages generated by the switched capacitor converter can be controlled. That is, going back to the previous example, the first operating mode may now reconfigure the switched capacitor converter receiving an input voltage V_{R} (generated by the linear regulator) such that a set of voltages V_{R}, (⅔)*V_{R}, and (⅓)*V_{R} is output, while the second operating mode may reconfigure the switched capacitor converter such that a set of voltages V_{R} and (½)*V_{R} is output. That is, the first and second operating modes may output different sets of voltages proportional to V_{R} (with an output level of V_{R} also being proportional to the regulated voltage by a proportionality constant of 1). The ability to separately control the level of the regulated voltage V_{R} and the configuration of the switched capacitor converter provides the ability to output a wide range of possible output voltages at low cost and small size (e.g., without requiring use of any magnetic components (e.g., inductors)).

Such a system including a controllable linear regulator and a reconfigurable switched capacitor converter may be beneficial in that the system provides a greater number of possible supply levels than systems using a supply generator that cannot be reconfigured and/or may more efficiently generate a fixed set of one or more supply levels as the voltage of the input power supply source varies. For example, in applications where the input voltage is a battery voltage, the battery voltage may vary over time. As one example, a battery voltage may initially be 5V when a battery is fully charged, but may discharge over time. If the battery has discharged such that its voltage level is 4V, it may be desirable to operate a switched capacitor converter in a second operating mode as described above, such that the switched capacitor converter outputs a voltage of 2V, and voltages of 4V and 2V are output. If the battery has discharged such that its voltage level is 3V, it may be desirable to operate a switched capacitor converter in a first operating mode as described above, such that the switched capacitor converter outputs a voltage at 2V and such that voltages at 3V and 2V are output, because half of 3V (1.5V) (as would be generated by the second operating mode) may be too low to drive components of a system. Reconfiguring a switched capacitor converter between different operating modes may also have advantages when the amount of power to be supplied to a PA varies (e.g., using envelope tracking to change the power to the PA as the RF amplitude input to the PA varies).

As discussed above, it may be advantageous to provide a low-cost power supply system that may yield high performance in applications such as mobile WiFi systems or cellular systems, where size and cost may be constraints. One might just use a linear regulator coupled between a battery and a PA to provide a fixed power supply. However, as discussed above, such a solution may be inefficient as the linear regulator dissipates power to provide the desired output voltage. Moreover, such a solution provides a single output voltage, which as discussed above may also be disadvantageous.

Systems, methods, circuits, devices, and techniques disclosed herein provide for power supply designs that provide discrete supply modulation with reduced loss, while still being low in cost and size.

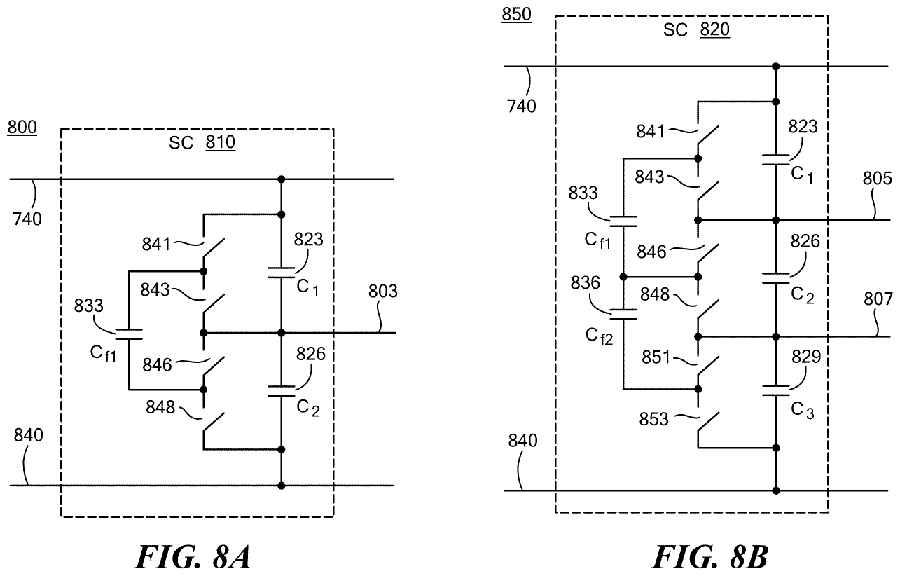

FIG. 7 is a diagram of a system 700 utilizing one or more linear regulators (e.g., linear regulator 710) and one or more switched capacitor converters (e.g., switched capacitor converter 720). System 700 may be coupled to energy source 510 (e.g., battery) at a pair of input terminals (e.g., one coupled to the positive terminal and one coupled to the negative terminal of energy source 510) and may be coupled to a load (e.g., RF amplifier 550) via a pair of output terminals (e.g., one coupled to the positive supply terminal and one coupled to the negative supply terminal of RF amplifier 550). A linear regulator 710 may be controlled (e.g., able to be programmatically reconfigured) by one or more controllers (e.g., controller(s) 155 as described with respect to FIG. 1B, controller(s) 815 as described with respect to FIG. 8) to draw power at the input terminals to output a regulated voltage V_{R} 740, which may be output to one or more switched capacitor converters (e.g., switched capacitor converter 720) and to one or more supply modulators (e.g., supply modulator 730). Switches in switched capacitor converter 720 may be controlled (e.g., able to be programmatically reconfigured) by the one or more controllers to generate one or more output voltages related to (e.g., proportional to) the regulated voltage V_{R}, and may output these one or more voltages to supply modulator 730. The regulated voltage V_{R} may also be output from switched capacitor converter 720 to supply modulator 730. In some embodiments, a second voltage level (e.g., a ground voltage (0V) from the ground terminal of energy source 510, a second voltage from another regulator) may also be received by switched capacitor converter 720 and this second level may also be passed from switched capacitor converter 720 to supply modulator 730. Supply modulator 730 may then be controlled (e.g., able to be programmatically reconfigured) by the one or more controllers to select between the voltage levels output from switched capacitor converter 720 to provide a desired supply voltage V_{SUPPLY} to PA 550 at any given time. Example architectures of a switched capacitor converter are further described herein, any of which may be used as switched capacitor converter 720. It should be appreciated that output voltage(s) of switched capacitor converter 720 may be larger and/or smaller than provided by linear regulator 710 as developed by the particular switched capacitor circuit used.

The one or more linear regulators (e.g., linear regulator 710) of system 700 and the one or more switched capacitor converters (e.g., switched capacitor converter 720) of system 700 may be operated separately so as to output different voltages to supply modulator 730. As one example, switched capacitor converter 720 may be configured to output a voltage that is ⅔ of regulated voltage V_{R}. Then, if energy source 510 (e.g., battery) provides a voltage of 3.8V, for example, linear regulator 710 may be configured to provide an output voltage of 3.3V and switched capacitor converter 720 may be configured to output a voltage of 2.2V (i.e., (⅔)*V_{R} (3.3V)). Supply modulator 730 may select between the two voltages, such that a voltage supply between 3.3V and 2.2V may be provided to PA 550. Such a system using a combination of one or more linear regulators (e.g., linear regulator 710) and one or more switched capacitor converters (e.g., switched capacitor converter 720) may be smaller and/or less costly than the examples described with respect to FIGS. 5 and 6 (e.g., due to smaller size and lower cost of a linear regulator and switched capacitor converter as compared to an inductor).

Although not shown in FIG. 7, one or more controllers may be used to control one or more subsystems of system 700. In some embodiments, the one or more controllers used for controlling system 700 may be constructed and may operate as discussed previously for controller(s) 155 of FIG. 1B, except that for system 700 the one or more controllers may have signal lines for controlling (e.g., programmatically reconfiguring) linear regulator 710, switched capacitor converter 720, and/or supply modulator 730, and the one or more controllers may receive feedback or feedforward signals regarding voltage and/or current levels associated with energy source 510, linear regulator 710, switched capacitor converter 720, supply modulator 730, PA 550, and/or with components in these subsystems.

FIG. 8A is a diagram 800 of an example switched capacitor converter 810. Switched capacitor converter 810 may be used, for example, to implement switched capacitor converter 720 of FIG. 7, though the disclosure is not so limited. For example, a regulated voltage V_{R} may be output from a linear regulator (e.g., linear regulator 710) on voltage rail 740, such as discussed above with respect to FIG. 7. Another voltage (e.g., 0V from the negative terminal of energy source 510, or another voltage from another regulator) may be supplied on voltage rail 840. Switched capacitor converter 810 comprises hold up capacitors C₁ 823 and C₂ 826 coupled in a stacked (or ladder) fashion between voltage rail 740 (supplying V_{R}) and voltage rail 840 (supplying a different voltage or a ground voltage (0V)). That is, capacitor C₁ is coupled between a voltage V_{R} 740 and a voltage at node 803, and capacitor C₂ is coupled between the voltage at node 803 and the voltage on rail 840.

Switched capacitor converter 810 further comprises four switches, a switch 841 and a switch 843 coupled between voltage V_{R} 740 and the voltage at node 803, and a switch 846 and a switch 848 coupled between the voltage at node 803 and the voltage on rail 840. Switched capacitor converter 810 also comprises a flying capacitor C_{f1} coupled at one end between switches 841 and 843 and coupled at the other end between switches 846 and 848. Switched capacitor converter 810 may be referred to as a ladder switched capacitor converter.

In a first phase of a switching cycle of switched capacitor converter 810, switch 843 and switch 848 may be turned on (with switch 841 and switch 846 turned off), and in a second phase of the switching cycle, switch 841 and switch 846 may be turned on (with switch 843 and switch 848 turned off). By switching in this manner, flying capacitor C_{f1} 833 balances the capacitor voltage levels of capacitors C₁ and C₂. Switched capacitor converter 810 may be used to output three voltage levels, the regulated voltage V_{R} 740 from the linear regulator (e.g., linear regulator 710), the voltage of voltage rail 840 (e.g., 0V), and a voltage at node 803 that is between (e.g., halfway between) voltage V_{R} and the voltage of rail 840.

FIG. 8B is a diagram 850 of another example switched capacitor converter 820.

Switched capacitor converter 820 may be used, for example, to implement switched capacitor converter 720 of FIG. 7, though the disclosure is not so limited. Like switched capacitor converter 810, switched capacitor converter 820 is a ladder switched capacitor converter. However, switched capacitor converter 820 adds one more capacitor (capacitor C₃ 829) to the stack of capacitors coupled between voltage rail 740 (supplying V_{R}) and voltage rail 840 (supplying a different voltage or a ground voltage (0V)), one more flying capacitor (C_{f2} 836), and two more switches 851 and 853.

That is, capacitor C₁ 823 is coupled between voltage V_{R} 740 and the voltage at node 805, capacitor C₂ 826 is coupled between the voltage at node 805 and the voltage at node 810, and capacitor C₃ 829 is coupled between the voltage at node 810 and the voltage on rail 840. Switched capacitor converter 820 also comprises six switches, a switch 841 and a switch 843 coupled between voltage V_{R} 740 and the voltage at node 805, a switch 846 and a switch 848 coupled between the voltage at node 805 and the voltage at node 810, and a switch 851 and a switch 853 coupled between the voltage at node 810 and the voltage on rail 840. Switched capacitor converter 820 further comprises a flying capacitor C_{f1} 833 coupled at one end between switches 841 and 843 and coupled at the other end between switches 846 and 848. Switched capacitor converter 820 still further comprises a flying capacitor C_{f2} 836 coupled at one end between switches 846 and 848 and coupled at the other end between switches 851 and 853.

In a first phase of a switching cycle of switched capacitor converter 820, switches 843, 848, and 853 may be turned on (with switches 841, 846, and 851 turned off), and in a second phase of the switching cycle, switches 841, 846, and 851 may be turned on (with switches 843, 848, and 853 turned off). By switching in this manner, flying capacitors C_{f1} 833 and C_{f2} 836 balance the capacitor voltage levels of capacitors C₁, C₂, and C₃. Switched capacitor converter 820 may be used to output four voltage levels, the regulated voltage V_{R} 740 from the linear regulator (e.g., linear regulator 710), the voltage of voltage rail 840 (e.g., 0V), the voltage at node 805 (e.g., ⅔ of the voltage difference between V_{R} 740 and the voltage on rail 840), and the voltage at node 810 (e.g., ⅓ of the voltage difference between V_{R} 740 and the voltage on rail 840).

Although an example of a switched capacitor converter 810 outputting three voltage levels and an example of a switched capacitor converter 820 outputting four voltage levels are described above, the disclosure is not so limited. A person of skill in the art would recognize, for example, that additional voltage levels may be output by providing adding capacitors in the stack of capacitors coupled between voltage V_{R} 740 and voltage rail 840, and by providing adding flying capacitors to balance the voltage levels of the capacitors. Such embodiments should be considered to be within the scope of the disclosure herein.

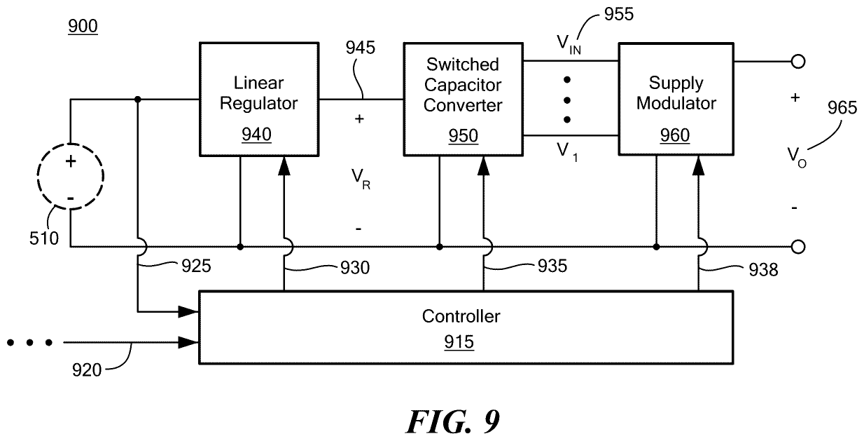

FIG. 9 is a diagram of an example system 900 utilizing one or more linear regulators (e.g., linear regulator 940), one or more switched capacitor converters (e.g., switched capacitor converter 950), one or more supply modulators (e.g., supply modulator 960), and one or more controllers (e.g., controller(s) 915). In some embodiments, an optional filtering or regulation circuit (e.g., comprising one or more impedance elements, such discussed with respect to optional filtering or regulation circuit 130 of FIG. 1A or optional filter circuit 180 of FIG. 1B) may be coupled to the output of supply modulator 960. The one or more linear regulators (e.g., linear regulator 940) may be considered to be a first stage circuit, while the one or more switched capacitor converters (e.g., switched capacitor converter 950) may be considered to be a second stage circuit. Although a linear regulator 940 is shown in FIG. 9, in some embodiments, different types of voltage regulation circuits may be used in place of, or in addition to, linear regulator 940. For example, a magnetic converter (e.g., buck, boost, buck-boost, flyback) may be used. As previously discussed, a linear regulator may have more dissipative loss than a magnetic converter (and thus be less efficient), but may be smaller in size (e.g., implemented on a small IC or with small components) and/or less expensive than a magnetic converter. Thus, use of a linear regulator may be advantageous in some applications, such as mobile applications, where size and/or cost may be a constraint.

System 900 may be coupled to energy source 510 (e.g., battery) at a pair of input terminals (e.g., one coupled to the positive terminal and one coupled to the negative terminal of energy source 510) and may be coupled to a load (e.g., RF amplifier) via a pair of output terminals (e.g., one coupled to the positive supply terminal of the RF amplifier and one coupled to the negative supply terminal of the RF amplifier). Linear regulator 940 may draw power from the input terminals to regulate from a voltage of energy source 510 (e.g., battery), such as a voltage of V_{BAT}, and may output a regulated voltage V_{R}. The voltage level of V_{R} may be set to a fixed value. Alternatively, the voltage level V_{R} may be selected from among multiple possible discrete values (e.g., based on current input battery voltage of energy source 510, based on RF PA output power or desired RF PA output power, based on available operating points for a digital predistortion (DPD) system, and/or based on other considerations). That is, the voltage level of V_{R} may be controllable by one or more controllers (e.g., controller(s) 915). In some embodiments, the one or more controllers (e.g., controller(s) 915) may receive feedback or feedforward signals from system 900 (e.g., reflecting battery voltage level of energy source 510, reflecting RF PA output power), and may control (e.g., programmatically control) the voltage level V_{R} to be output by linear regulator 940 based on these signals. In some embodiments, the regulated voltage V_{R} may be adjusted in conjunction with a digital pre-distortion algorithm that provides pre-distortion for a modulated RF waveform. For example, one or more controllers implementing a DPD algorithm may send one or more signals (e.g., signal 920) to one or more controllers (e.g., controller(s) 915), and the one or more controllers receiving the one or more signals may control linear regulator 940 accordingly. In this way, the regulated voltage V_{R} may be adjusted to achieve a more optimal modulated RF performance, or to minimize loss. In some embodiments, the one or more controllers (e.g., controller(s) 915) may control (e.g., programmatically reconfigure) linear regulator 940, switched capacitor converter 950, and/or supply modulator 960 based on one or more signals (e.g., reflecting battery level of energy source 510, based on RF PA output power or desired RF PA output power, based on available operating points of a DPD system, and/or based on other considerations) received by the one or more controllers. In some embodiments, the one or more controllers (e.g., controller(s) 915) may control (e.g., programmatically control) linear regulator 940 with one or more control signals 930, switched capacitor converter 950 with one or more control signals 935, and/or supply modulator 960 with one or more control signals 938, based on one or more signals received from one or more controllers implementing a DPD algorithm.

In the example shown in FIG. 9, a second stage circuit is realized as a switched capacitor converter 950. Switched capacitor converter 950 in the example of FIG. 9 is designed to generate multiple regulated voltages for output to a PA via supply modulator 960 (e.g., providing discrete supply modulation). Switched capacitor converter 950 in the example of FIG. 9 is designed to produce and regulate one or more voltages related to V_{R} according to a designed ratio. That is, switched capacitor converter 950 of FIG. 9 may be configured to output a set of one or more voltages V₁, . . . , V_{N} proportional to V_{R}. Switched capacitor converter 950 of FIG. 9 may be configured to output a set of voltages V₁, . . . , V_{N} that is ratiometrically related to voltage V_{R}. In some embodiments, switched capacitor converter 950 may comprise switched capacitor converter 810 of FIG. 8A or switched capacitor converter 820 of FIG. 8B, though the disclosure is not so limited. In some embodiments, one or more controllers 915 may receive one or more signals representing one or more output voltages of switched capacitor converter 950, and may control linear regulator 940 to output a selected voltage level to switched capacitor converter 950 based on the one or more signals, thereby adjusting one or more voltage levels output from switched capacitor converter 950 to one or more reference voltage levels. In some embodiments, voltage V_{R} may be coupled to supply modulator 960. In some embodiments, a voltage of 0V from the ground terminal of energy source 510 may be coupled to supply modulator 960. Thus, supply modulator 960 may be controlled (e.g., programmatically reconfigured) by one or more signals (e.g., signals 938) from one or more controllers (e.g., controller(s) 915) to select from voltages V₁, . . . , V_{N}. In embodiments where voltage V_{R} and/or 0V are also coupled to supply modulator 960, supply modulator 960 may also be controlled (e.g., programmatically reconfigured) by the one or more signals from the one or more controllers to select from one of these voltages. Supply modulator 960 may output the selected voltage as a voltage V_{SUPPLY} (shown here in FIG. 9 as V_{O}) 965 to a PA (not shown).

In some embodiments, switched capacitor converter 950 may be reconfigurable. In such an embodiment, and as further discussed below herein, one or more controllers (e.g., controller(s) 915) may control (e.g., programmatically reconfigure) switches in switched capacitor converter 950 to reconfigure switched capacitor converter 950 to generate different sets of voltages (e.g., different voltage patterns). For example, one or more controllers (e.g., controller(s) 915) may control switches in switched capacitor converter 950 to generate a first set of one or more output voltages in a first operating mode, and a second different set of one or more output voltages in a second operating mode. In some embodiments, the one or more controllers may reconfigure switched capacitor converter 950 based on one or more signals (e.g., reflecting battery level of energy source 510, reflecting one or more output voltages of switched capacitor converter 950, based on RF PA output power or desired RF PA output power, based on available operating points of a DPD system, and/or based on other considerations) received by the one or more controllers. The number of operating modes and sets of output voltages may depend on the design of the switched capacitor converter. Any number of different operating modes outputting any number of different sets of voltages may be provided, depending on the design of the switched capacitor converter.

In some embodiments, a connection point between linear regulator 940 and switched capacitor converter 950 may be reconfigurable. In such an embodiment, and as further discussed below herein, one or more controllers (e.g., controller(s) 915) may control (e.g., programmatically reconfigure) one or more switches (not shown in FIG. 9) to change the connection point where an output of linear regulator 940 connects to switched capacitor converter 950 to produce different sets of voltages (e.g., different voltage patterns). For example, one or more controllers (e.g., controller(s) 915) may control one or more switches between linear regulator 940 and switched capacitor converter 950 to generate a first set of output voltages in a first operating mode, and a second different set of output voltages in a second operating mode. In some embodiments, the one or more controllers may change the connection point(s) based on one or more signals (e.g., reflecting battery level of energy source 510, based on RF PA output power or desired RF PA output power, based on available operating points of a DPD system, and/or based on other considerations) received by the one or more controllers. The number of operating modes and sets of output voltages may depend on the number of switchable connection points between the linear regulator and the switched capacitor converter, and on the design of the switched capacitor converter.

In some embodiments, a linear regulator 940, a switched capacitor converter 950 and/or a connection point between linear regulator 940 and switched capacitor converter 950 may be reconfigurable. In such an embodiment, and as further discussed below herein, one or more controllers (e.g., controller(s) 915) may control (e.g., programmatically reconfigure) linear regulator 940, switches in switched capacitor converter 950, and/or one or more switches between linear regulator 940 and switched capacitor converter 950 to generate different sets of output voltages in different operating modes. The number of operating modes and sets of output voltages may depend on the design of the switched capacitor converter and the number of switchable connections between the linear regulator and the switched capacitor converter. Any number of different operating modes outputting any number of different sets of voltages may be provided, depending on the design of the switched capacitor converter and the number of switchable connections between the linear regulator and the switched capacitor converter. In some embodiments, the one or more controllers may control linear regulator 940, switches in switched capacitor converter 950, and/or one or more switches between linear regulator 940 and switched capacitor converter 950 based on one or more signals (e.g., reflecting battery level of energy source 510, based on RF PA output power or desired RF PA output power, based on available operating points of a DPD system, and/or based on other considerations) received by the one or more controllers. Thus, by reconfiguring the linear regulator, switched capacitor converter, and/or the connection between the linear regulator and the switched capacitor converter, the supply generator may provide a scaling of outputs with respect to the regulated voltage V_{R} for different configurations.

In some embodiments, linear regulator 940 may comprise a plurality of linear regulators. Which of the linear regulators is actively regulating its output, one or more connection points between the active linear regulator(s) and switched capacitor converter 950, and/or switched capacitor converter 950 itself, may be reconfigurable. In such embodiments, one or more controllers (e.g., controller(s) 915) may control (e.g., programmatically reconfigure) which of the linear regulators is active, and/or one or more switches (not shown in FIG. 9) may be used to change the connection point(s) where an output of the active linear regulator(s) connects to switched capacitor converter 950, and/or the configuration of switched capacitor converter 950, to produce different sets of voltages (e.g., different voltage patterns). For example, the one or more controllers may receive a signal related to at least one of a voltage level of energy source 510 or a desired RF output power of the RF amplifier, and may control the linear regulators to switch from a first linear regulator outputting a first regulated voltage to a second linear regulator to output a second regulated voltage different than the first regulated voltage to switched capacitor converter 950. Any number of different operating modes producing any number of sets of different output voltages may be provided by selecting the number and configuration of linear regulators that may be activated by a controller (e.g., controller(s) 915), the number and configuration of switchable connection points between each of the linear regulators and switched capacitor converter 950 that can be controlled by the controller (e.g., controller(s) 915), and/or the configuration of switched capacitor converter 950 that can be controlled by the controller (e.g., controller(s) 915). In some embodiments, the one or more controllers may control the number and configuration of linear regulators activated by the controller, the number and configuration of switchable connection points between each of the linear regulators and switched capacitor converter 950, and/or the configuration of switched capacitor converter 950 based on one or more signals (e.g., reflecting battery level of energy source 510, based on RF PA output power or desired RF PA output power, based on available operating points of a DPD system, and/or based on other considerations) received by the one or more controllers. Depending on the particular application in which the system is going to be used, a particular combination of linear regulators, switchable connection points, and/or switched capacitor converter configuration may be designed to provide a desired number of operating modes with desired sets of output voltages.

Supply modulator 960 may be considered to be a third stage of system 900. Supply modulator 960 may select from among multiple (two or more) voltages generated by switched capacitor converter 950 (and optionally from voltages bypassing switched capacitor converter 950) and related to the voltage V_{R} output by linear regulator 940. Taken together, these three stages (linear regulator, switched capacitor converter, supply modulator) may comprise a supply generation/supply modulation system. The operation of the supply generation/supply modulation system may be reconfigurable to provide different discrete voltage outputs depending on a selected regulation voltage V_{R}, selected connections between linear regulator 940 and switched capacitor converter 950, selected switched capacitor converter operating modes, and/or other considerations. As just one example, one may modulate between voltage V_{R} and a voltage (½)*V_{R}, modulate between a voltage V_{R} and a voltage (⅔)*V_{R}, or may modulate between a voltage V_{R}, a voltage (⅔)*V_{R}, and a voltage (⅓)*V_{R}, depending upon a selected operating mode.

Table 1 below illustrates modulation voltage sets that may be obtained with such a system based on two different example regulation set points (i.e., output levels) of V_{R} (4V and 3V, respectively). SC Cfg #1 in Table 1 relates to a first operating mode, where switched capacitor converter 950 generates voltages at ratios of ⅔ and ⅓ of the voltage V_{R} output from linear regulator 940. SC Cfg #2 in Table 1 relates to a second operating mode, where switched capacitor converter 950 generates a voltage at a ratio of ½ of the voltage V_{R} output from linear regulator 940.

TABLE 1

| | SC Cfg #1 | SC Cfg #2 | SC Cfg #1 | SC Cfg #2 |
|---|---|---|---|---|
| | V_{R} = 4 V | V_{R} = 4 V | V_{R} = 3 V | V_{R} = 3 V |
| V_{R} | 4.00 V | 4.00 V | 3.00 V | 3.00 V |
| (2/3)*V_{R} | 2.67 V | | 2.00 V | |
| (1/2)*V_{R} | | 2.00 V | | 1.50 V |
| (1/3)*V_{R} | 1.30 V | | 1.00 V | |

A particular operating mode may be most optimal depending on factors such as the input voltage from energy source 510 (e.g., battery), output power of the PA (not shown), and/or other operating characteristics associated with the PA.

In some embodiments, one or more controllers implementing a digital pre-distortion (DPD) algorithm may send one or more signals to controller(s) 915 commanding an optimal configuration for system 900, and controller(s) 915 may control switches of system 900 to implement that optimal configuration. These configuration adjustments may include, for example, adjusting voltage conversion ratios provided by switched capacitor converter 950 by switching operating modes and/or adjusting the regulated output voltage V_{R} of linear regulator 940.

For example, consider an application where a PA used with system 900 is operable (e.g., with good linearity) down to a supply voltage of 1.8V, and energy source 510 is a battery with a voltage that varies between 3-5V. In this case, one might choose operating mode 2 (i.e., SC Cfg #2) with the output voltage V_{R} of linear regulator 940 set to 4V when the battery voltage is high enough to support V_{R} of 4V from linear regulator 940, thereby allowing modulation of the PA input voltage between 4V and 2V. One might choose operating mode 1 (i.e., SC Cfg #1) with the output voltage V_{R} of linear regulator 940 set to 3V for lower battery voltages, thereby allowing modulation of the PA input voltage between 3V and 2V. Other configurations and linear regulator set points may be similarly selected for different battery voltage ranges and different allowable PA input voltage ranges. One might, for example, select set points for the output voltage V_{R} of linear regulator 940 and/or select the operating mode of switched capacitor converter 950 based on the battery range and/or usable PA input voltage range (e.g., to minimize energy usage for a specified operating profile).

Controller(s) 915 may be constructed as previously described with respect to controller(s) 155 of FIG. 1B. However, controller(s) 915 may instead be connected via signal lines (e.g., digital signal lines) to linear regulator 940, switched capacitor converter 950 and/or supply modulator 960 for controlling these subsystems (e.g., via switches, such as transistors, in these subsystems), and may receive feedback and/or feedforward signals associated with voltage or current levels of energy source 510, linear regulator 940, switched capacitor converter 950, supply modulator 960, a PA (not shown), or any components within these subsystems. Controller(s) 915 may control linear regulator 940, switched capacitor converter 950, and/or supply modulator 960 based on one or more of these feedback and/or feedforward signals. In some embodiments, controller(s) 915 may receive one or more digital control logic (DCL) signals over a digital interface (e.g., DCL interface) from one or more other controllers that control operation of controller(s) 915.

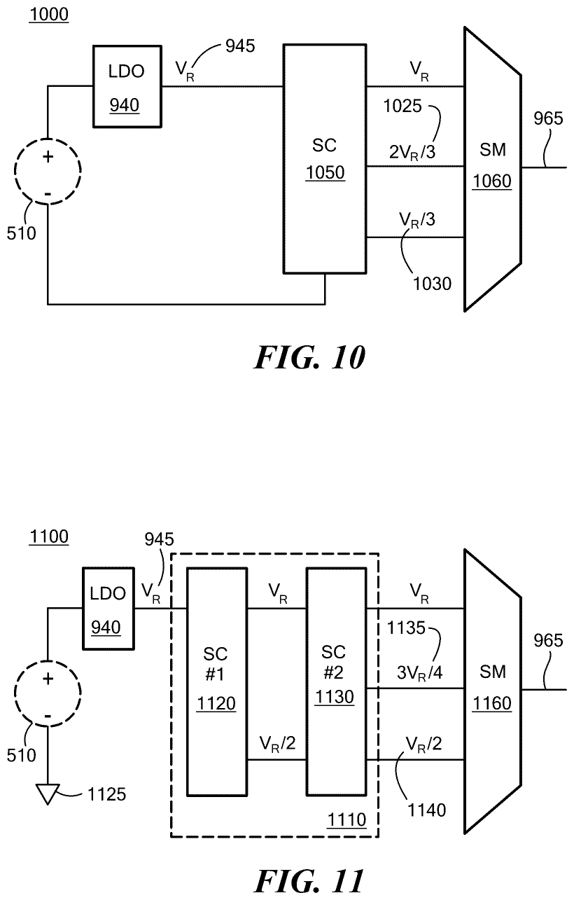

FIG. 10 is a diagram of an example system 1000 utilizing a linear regulator 940 (shown in FIG. 10 as an LDO), a switched capacitor converter 1050, and a supply modulator 1060. In some embodiments, system 1000 may be one implementation of system 900 of FIG. 9, with linear regulator 940 corresponding to linear regulator 940 of system 900, switched capacitor converter 1050 corresponding to switched capacitor converter 950 of system 900, and supply modulator 1060 corresponding to supply modulator 960 of system 900. Linear regulator 940 may be considered to be a first stage circuit, while switched capacitor converter 1050 may be considered to be a second stage circuit. Although a linear regulator 940 is shown in FIG. 10, and shown as an LDO, in some embodiments different types of voltage regulation circuits may be used in place of, or in addition to, linear regulator 940. For example, a different type of linear regulator or a magnetic converter (e.g., buck, boost, buck-boost, flyback) may be used. As previously discussed, a linear regulator may have more dissipative loss than a magnetic converter (and thus be less efficient), but may be smaller in size (e.g., implemented on a small IC or with small components) and/or less expensive than a magnetic converter. Thus, use of a linear regulator may be advantageous for some applications, such as mobile applications, where size and/or cost may be a constraint.

Linear regulator 940 may output a regulated voltage V_{R}. The voltage level of V_{R} may be controllable (e.g., programmable) by one or more controllers (e.g., controller(s) 915, such as discussed with respect to FIG. 9), as previously discussed. In some embodiments, the regulated voltage V_{R} may be adjusted in conjunction with a digital pre-distortion algorithm that provides pre-distortion for a modulated RF waveform. For example, one or more controllers implementing a DPD algorithm may send one or more signals to one or more controllers (e.g., controller(s) 915), and the one or more controllers may control linear regulator 940 accordingly. In this way, the regulated voltage V_{R} may be adjusted to achieve a more optimal modulated RF performance, or to minimize loss. In some embodiments, the one or more controllers may control linear regulator 940, switched capacitor converter 1050, and/or supply modulator 1060 based on one or more signals received from one or more controllers implementing a DPD algorithm.

In the example shown in FIG. 10, a second stage circuit is realized as a switched capacitor converter 1050. Switched capacitor converter 1050 in the example of FIG. 10 may be designed to produce regulated voltages below V_{R} according to a designed ratio. That is, switched capacitor converter 1050 in the example of FIG. 10 may be configured to output a voltage (⅔)*V_{R} and a voltage of (⅓)*V_{R}. In some embodiments, switched capacitor converter 1050 may comprise switched capacitor converter 820 of FIG. 8B, though the disclosure is not so limited. Supply modulator 1060 may be controlled by one or more controllers (e.g., controller(s) 915) to select from voltage V_{R} 945 (output of linear regulator 940), (⅔)*V_{R} 1025 (one output of switched capacitor converter 1050), and (⅓)*V_{R} 1030 (another output of switched capacitor converter 1050). Thus, supply modulator 860 may select from voltages V_{R}, (⅔)*V_{R}, and (⅓)*V_{R}, and output the selected voltage as a voltage V_{SUPPLY} 965 to a PA (not shown). Although not shown in FIG. 10, in some embodiments, a ground voltage rail from energy source 510 may also be passed from switched capacitor converter 1050 to supply modulator 1060. In such an embodiment, supply modulator 1060 may select from voltages V_{R}, (⅔)*V_{R}, (⅓)*V_{R}, and 0V, and output the selected voltage as a voltage V_{SUPPLY} 965 to a PA (not shown).

In some embodiments, switched capacitor converter 1050 may be reconfigurable. In such an embodiment, and as further discussed below herein, one or more controllers (e.g., controller(s) 915) may control switches in switched capacitor converter 1050 to reconfigure switched capacitor converter 1050 to produce different sets of one or more voltages (e.g., different voltage patterns). For example, in a first operating mode, one or more controllers (e.g., controller(s) 915) may control switches in switched capacitor converter 1050 to generate output voltages of (⅔)*V_{R} and (⅓)*V_{R}. Thus, when switched capacitor converter 1050 is operated in this mode, supply modulator 1060 may select between voltages of V_{R} 945 (the output of linear regulator 940), (⅔)*V_{R} 1025 (one output of switched capacitor converter 1050), (⅓)*V_{R} 1030 (another output of switched capacitor converter 1050), and 0V (if the ground rail from energy source 510 is connected to supply modulator 1060). In a second operating mode, the one or more controllers (e.g., controller(s) 915) may control the switches in switched capacitor converter 1050 to generate an output voltage of (½)*V_{R}. Thus, when switched capacitor converter 950 is operated in this mode, supply modulator 1060 may select between voltages of V_{R} (the output of linear regulator 940), (½)*V_{R} (the output of switched capacitor converter 1050), and 0V (if the ground rail from energy source 510 is connected to supply modulator 1060).

In some embodiments, one or more controllers (controller(s) 915) may control switches in switched capacitor converter 1050 to reconfigure switched capacitor converter 1050 from the first operating mode to the second operating mode by shorting the (⅓)*V_{R} output of switched capacitor converter 1050 to ground, which may cause switched capacitor converter 1050 to output a voltage of (½)*V_{R}, rather than (⅔)*V_{R} and (⅓)*V_{R}. For example, in some embodiments, the first operating mode may be implemented using switched capacitor converter 820 of FIG. 8B, and the second operating mode may be implemented by turning on a switch to short node 810 to rail 840 of switched capacitor 820, thereby causing node 805 to output a voltage of (½)*V_{R}.

As will be further discussed below, the ability to reconfigure the switched capacitor converter may provide a better tradeoff between performance and loss than would otherwise be possible. As one example, suppose a PA (not shown) used with system 1000 is operable (e.g., with good linearity) down to a voltage supply level of 1.8V, and energy source 510 (e.g., battery) varies between 3-5V. In this case, one or more controllers (e.g., controller(s) 915) may choose to operate switched capacitor converter 1050 in the second operating mode with the regulated voltage V_{R} set at 4V when energy source 510 (e.g., battery) has a voltage high enough to support a regulated voltage V_{R} of 4V from linear regulator 940, allowing modulation of the PA input voltage by supply modulator 1060 between 4V and 2V. The one or more controllers (e.g., controller(s) 915) may choose to operate switched capacitor converter 1050 in the first operating mode with the regulated voltage V_{R} set at 3V when energy source 510 (e.g., battery) has a lower voltage but can support a regulated voltage V_{R} of 3V from linear regulator 940, allowing modulation of the PA input voltage by supply modulator 1060 between 3V and 2V.

FIG. 11 is a diagram of an example system 1100 utilizing a linear regulator 940 (shown in FIG. 11 as an LDO), a switched capacitor converter 1110 with multiple stages, and a supply modulator 1160. In some embodiments, system 1100 may be one implementation of system 900 of FIG. 9, with linear regulator 940 corresponding to linear regulator 940 of system 900, switched capacitor converter 1110 corresponding to switched capacitor converter 950 of system 900, and supply modulator 1160 corresponding to supply modulator 960 of system 900. Linear regulator 940 may be considered to be a first stage circuit, while switched capacitor converter 1110 may be considered to be a second stage circuit. Switched capacitor converter 1110 may have multiple stages. In the example shown in FIG. 11, switched capacitor converter 1110 has two stages, a first stage 1120 and a second stage 1130. Although a linear regulator 940 is shown in FIG. 11, and shown as an LDO, in some embodiments different types of linear regulators or other voltage regulation circuits (e.g., buck, boost, buck-boost, flyback) may be used in place of, or in addition to, linear regulator 940, as discussed above with respect to FIG. 9.

Linear regulator 940 may output a regulated voltage V_{R}. The voltage level of V_{R} may be controllable (e.g., programmable) by one or more controllers (e.g., controller(s) 915, such as previously discussed with respect to FIG. 9), as previously discussed. In some embodiments, the regulated voltage V_{R} may be adjusted in conjunction with a digital pre-distortion algorithm that provides pre-distortion for a modulated RF waveform, as previously discussed (see, e.g., discussion with respect to FIGS. 9, 10).

In the example of FIG. 11, a second stage circuit is realized as a switched capacitor converter 1110 having two stages, a first stage 1120 and a second stage 1130. Switched capacitor converter 1110 in the example of system 1100 is designed to produce regulated voltages below V_{R} according to a designed ratio. That is, switched capacitor converter 1110 in the example of FIG. 11 is configured to output a voltage of (¾)*V_{R} and (½)*V_{R}. More specifically, first stage 1120 of switched capacitor converter 1110 is configured to generate a voltage of (½)*V_{R}, while second stage 1130 of switched capacitor converter 1110 is configured to generate a voltage of (¾)*V_{R}. In the example shown in FIG. 11, each stage of switched capacitor converter 1110 is configured as a voltage halver, with first stage 1120 coupled between the regulated voltage V_{R} output from linear regulator 940 and ground (and generating an output voltage of (½)*V_{R} at output 1140), and with second stage 1130 differentially coupled between the regulated voltage V_{R} output from linear regulator 940 and the output of first stage 1120 (and thus generating an output voltage of (¾)*V_{R} ((V_{R}−(½)*V_{R})/2) at output 1135). That is, in some embodiments, first stage 1120 may comprise switched capacitor converter 810 of FIG. 8A (with rail 740 coupled to V_{R} and rail 840 coupled to ground (e.g., 0V)), and second stage 1130 may comprise switched capacitor converter 810 of FIG. 8A (with rail 740 coupled to V_{R} and rail 840 coupled to node 803 (or the V_{R}/2 output of first stage 1120). Supply modulator 1160 may be controlled by one or more signals from one or more controllers (e.g., controller(s) 915) to select from voltage V_{R} 945 (output of linear regulator 940), (¾)*V_{R} (output of second stage 1130 of switched capacitor converter 1110), and (½)*V_{R} (output of first stage 1120 of switched capacitor converter 1110). Thus, supply modulator 1160 may select from voltages V_{R}, (¾)*V_{R}, and (½)*V_{R}, and output the selected voltage as a voltage V_{SUPPLY} 965 to a PA (not shown). Although not shown in FIG. 11, in some embodiments, a ground voltage rail from energy source 510 may also be connected to supply modulator 1160. In such an embodiment, supply modulator 1160 may select from voltages V_{R}, (¾)*V_{R}, (½)*V_{R}, and 0V, and output the selected voltage as a voltage V_{SUPPLY} 965 to a PA (not shown). Moreover, it will be appreciated that the switched capacitor circuit of stage 1120 and/or the switched capacitor circuit of stage 1130 may be controlled to regulate their outputs (e.g., to voltages that are below their ratiometric output levels) by controlling their switching frequencies and/or duty ratios as a function of their output voltages. This may yield supply modulator voltages 1140 and 1135 that may be regulated at non-ratiometric values from V_{R}. This may provide some linearity benefits in some cases.

In some embodiments, switched capacitor converter 1110 of system 1100 may be reconfigurable. In some embodiments, one of first stage 1120 or second stage 1130 may be reconfigurable. In some embodiments, both first stage 1120 and second stage 1130 may be reconfigurable. In such embodiments, and as further discussed below herein, one or more controllers (e.g., controller(s) 915) may control switches in switched capacitor converter 1110 (e.g., in first stage 1120 and/or in second stage 1130) to produce different sets of one or more voltages (e.g., different voltage patterns). For example, the one or more controllers may control switches in switched capacitor converter 1110 to reconfigure switched capacitor converter 1110 between different operating modes, each of the operating modes configured to generate a set of output voltages. The output voltages in a set and/or number of output voltages in a set may differ between the different operating modes.

Using multiple stages of a switched capacitor converter may allow for realization of a wider range of voltage conversion ratios within the switched capacitor converter. However, this realization of a wider range of voltage conversion ratios may come at the expense of physical component solution size, as more components (e.g., switches, capacitors) may be required to implement such a solution.

Although FIG. 10 shows an example system 1000 that outputs voltages V_{R}, (⅔)*V_{R}, and (⅓)*V_{R}, and although FIG. 11 shows an example system 1100 that outputs voltages V_{R}, (¾)*V_{R}, and (½)*V_{R}, the disclosure is not so limited. One of skill in the art would recognize that different ratios of voltages may be generated depending on the design of the switched capacitor converter. As just one example, first stage 1120 of system 1100 may be designed to generate multiple output voltages, and second stage 1130 of system 1100 may be designed to allow for reconfiguration to connect to different ones of the outputs of first stage 1120, therefore allowing for further reconfiguration of possible conversion ratios output by system 1100. Moreover, by adjusting the switching frequency of a switched capacitor converter and/or duty ratio, one or more outputs of the switched capacitor converters may be regulated to non-ratiometric values with respect to the voltage input to the switched capacitor converter.

In some embodiments, a switched capacitor converter (e.g., switched capacitor converter 1050, switched capacitor converter 1110) may be “fixed” to generate a set of output voltages. In other embodiments, as previously discussed, a switched capacitor converter (e.g., switched capacitor converter 1050, switched capacitor converter 1110) may be reconfigured (e.g., by one or more controllers, such as controller(s) 915, controlling one or more switches) to change the set of output voltages generated by the switched capacitor converter.

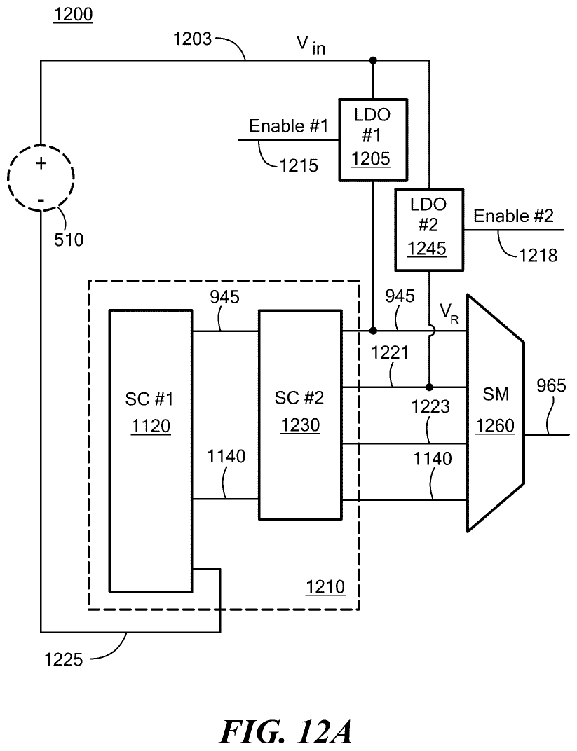

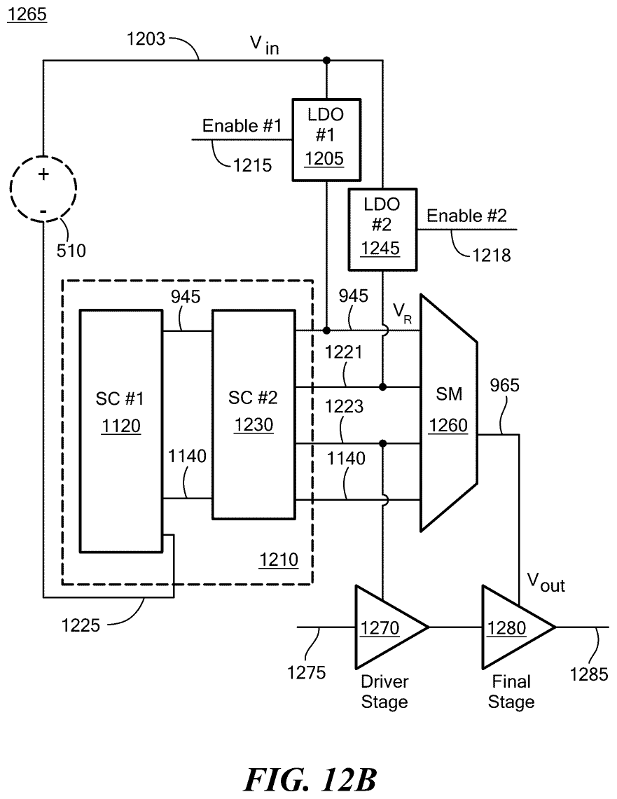

FIG. 12A is a diagram of an example system 1200 utilizing two linear regulators (a linear regulator 1205 (shown in FIG. 12A as an LDO labeled LDO #1) and linear regulator 1245 (shown in FIG. 12A as an LDO labeled LDO #2)), a switched capacitor converter 1210, and a supply modulator 1260. In some embodiments, system 1200 may be one implementation of system 900 of FIG. 9, with linear regulators 1205, 1245 corresponding to the one or more linear regulators 940 of system 900, switched capacitor converter 1210 corresponding to switched capacitor converter 950 of system 900, and supply modulator 1260 corresponding to supply modulator 960 of system 900. In some embodiments, linear regulator 1205 may correspond to linear regulator 940 of system 1100 of FIG. 11, switched capacitor converter 1210 may correspond to switched capacitor converter 1110 of system 1100, and supply modulator 1260 may correspond to supply modulator 1160 of system 1100. That is, in some embodiments, system 1200 may be the same as system 1100, except that an additional linear regulator (LDO #2) 1245 is coupled between the positive terminal (Vin) of energy source 510 and an output of second stage 1230 of switched capacitor converter 1210, and except that second stage 1230 in system 1200 is configured to output four voltage levels (and thus may comprise switched capacitor converter 850 of FIG. 8B in some embodiments). As one example, a regulated voltage V_{R} may be set at 3.6V. First stage 1120 may be implemented as a voltage halver (e.g., switched capacitor converter 810 of FIG. 8A), and may therefore output a voltage 1140 of 1.8V. Second stage 1230 may be implemented to output V_{R} (e.g., 3.6V), voltage 1140 (e.g., 1.8V), and ⅔ (e.g., 3.0V) and ⅓ (e.g., 2.4V) of the voltage difference between V_{R} 945 and voltage 1140. Although linear regulator 1245 is shown as being coupled to output 1221 of second stage 1230, the disclosure is not so limited. A linear regulator may be coupled to any node within switched capacitor converter 1210.

Linear regulators 1205, 1245 may be considered to be a first stage circuit, while switched capacitor converter 1210 may be considered to be a second stage circuit. Although linear regulators 1205, 1245 are shown in FIG. 12A, and shown as LDOs, in some embodiments different types of linear regulators or other voltage regulation circuits (e.g., buck, boost, buck-boost, flyback) may be used in place of, or in addition to, linear regulator 1205 and/or linear regulator 1245, as discussed above with respect to FIG. 9. One skilled in the art would further appreciate that such regulators may be implemented as two distinct regulators, each connected to a different node of switched capacitor converter 1210 or as a single regulator with its single output selectively connected to different nodes of switched capacitor converter 1210 by way of switches.

The difference between the voltage applied by an energy source (e.g., energy source 510) and a regulated output voltage from a linear regulator (e.g., an LDO) may be proportional to the linear regulator's efficiency. Therefore, it may be desirable to minimize the difference between the voltage input to the linear regulator and the voltage output from the linear regulator. A linear regulator may be incapable of producing a regulated output voltage that is greater than its input voltage. Like with system 1100 of FIG. 11, in system 1200 of FIG. 12A the output of linear regulator 1205 (LDO #1) is coupled to an input of first stage 1120 of switched capacitor converter 1210, to an input of second stage 1230 of switched capacitor converter 1210, and to an input of supply modulator 1260. In system 1200, the output of linear regulator 1245 (LDO #2) is coupled to an output of second stage 1230 of switched capacitor converter 1210.

As previously discussed, the voltage supplied by energy source 510 may vary, such as when energy source 510 comprises a battery. In system 1200, when the voltage supplied by energy source 510 is greater than a desired regulated voltage V_{R}, linear regulator 1205 may be active (e.g., controlled to be active by one or more controllers (e.g., via an enable #1 signal line 1215), such as controller(s) 915 as described with respect to FIG. 9) and may provide regulated voltage V_{R} at 945, and linear regulator 1245 may be inactive (e.g., controlled to be inactive by one or more controllers (e.g., via an enable #2 signal line 1218)). When the voltage supplied by energy source 510 is lower than desired regulated voltage V_{R}, linear regulator 1245 may be active and may provide a regulated voltage at 1221, and linear regulator 1205 may be inactive. That is, when the voltage supplied by energy source 510 is lower than desired regulated voltage V_{R}, linear regulator 1245 may be used in combination with second stage 1230 and/or first stage 1120 of switched capacitor converter 1210 to generate the desired regulated voltage V_{R}. Stated another way, the output of linear regulator 1245 may be input into switched capacitor converter 1210 at 1221, and switched capacitor converter 1210 may be used to boost the voltage to the desired regulated voltage V_{R} at 945. Thus, when the voltage supplied by energy source 510 is greater than the desired regulated voltage V_{R}, linear regulator 1205 may be used to provide the regulated voltage V_{R}, thereby improving efficiency by minimizing the power loss of the active regulator. However, when the voltage supplied by energy source 510 is lower than the desired regulated voltage V_{R}, the desired regulated voltage V_{R} may still be achieved by using linear regulator 1245 and switched capacitor converter 1210. In some embodiments, rather than activating one of linear regulator 1205 or linear regulator 1245 and deactivating the other of the linear regulators, both linear regulators 1205, 1245 may be active at the same time, but the linear regulators may be controlled such that one of the linear regulators is dominant in providing the desired regulated voltage V_{R} at 945.

FIG. 12B is a diagram of an example system 1265 utilizing multiple linear regulators and two stages of a switched capacitor converter to provide ratiometric supply levels, where one of the supply levels powers a driver stage of an amplifier and another one of the supply levels powers a final stage of an amplifier. That is, system 1265 may be the same as system 1200, except that voltage 1223 (e.g., 2.4V from the example discussed with respect to FIG. 12A) is used to supply a driver stage 1270 of an amplifier, and output V_{SUPPLY} (or Vout) 965 from supply modulator 1260 is used to supply a final stage 1280 of the amplifier. An RF signal (e.g., cellular or WiFi signal) 1275 may then be passed through driver stage 1270 and final stage 1280 and output as signal 1285.

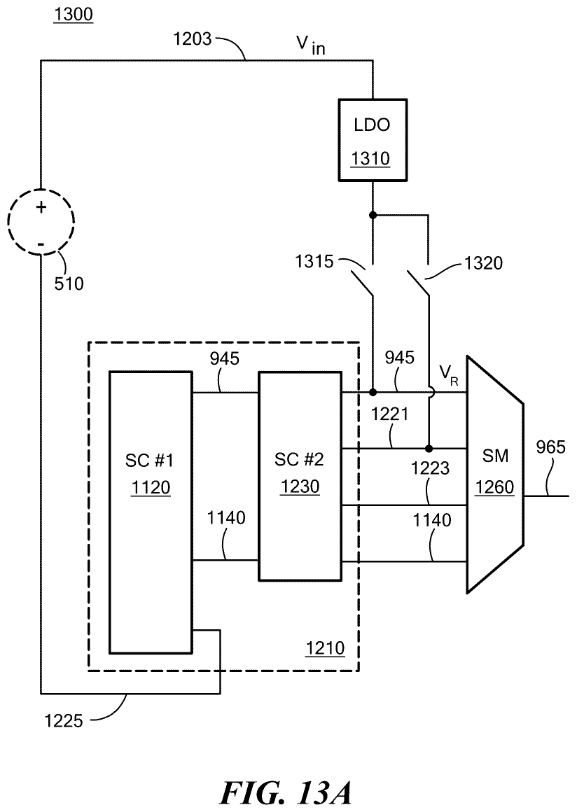

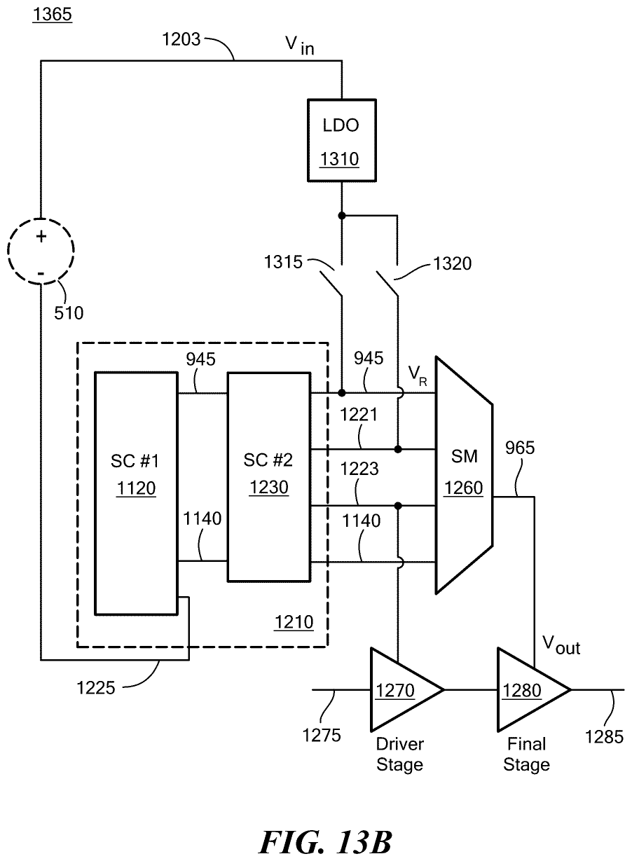

FIG. 13A is a diagram of an example system 1300 utilizing a linear regulator 1310 shown in FIG. 13A as an LDO) and two stages of a switched capacitor converter to provide ratiometric supply levels, where a connection point of an output of the linear regulator to the switched capacitor converter can be reconfigured via switches. In some embodiments, system 1300 may be one implementation of system 900 of FIG. 9, with linear regulator 1310 corresponding to linear regulator 940 of system 900, switched capacitor converter 1210 corresponding to switched capacitor converter 950 of system 900, and supply modulator 1260 corresponding to supply modulator 960 of system 900. In some embodiments, linear regulator 1310 may correspond to linear regulator 940 of system 1100 of FIG. 11, switched capacitor converter 1210 may correspond to switched capacitor converter 1110, and supply modulator 1260 may correspond to supply modulator 1160 of system 1100. That is, in some embodiments, system 1300 may be the same as system 1100, except that a linear regulator (e.g., linear regulator 1310) may be selectively coupled to different connection points of switched capacitor converter 1210, and except that second stage 1230 in system 1200 is configured to output four voltage levels (and thus may comprise switched capacitor converter 850 of FIG. 8B in some embodiments). As one example, a regulated voltage V_{R} may be set at 3.6V. First stage 1120 may be implemented as a voltage halver (e.g., switched capacitor converter 810 of FIG. 8A), and may therefore output a voltage 1140 of 1.8V. Second stage 1230 may be implemented to output V_{R} (e.g., 3.6V), voltage 1140 (e.g., 1.8V), and ⅔ (e.g., 3.0V) and ⅓ (e.g., 2.4V) of the voltage difference between V_{R} 945 and voltage 1140. Although linear regulator 1310 is shown as being selectively coupled via switch 1315 to V_{R} 945 or via switch 1320 to output 1221 of second stage 1230, the disclosure is not so limited. A linear regulator may be selectively coupled to any node within switched capacitor converter 1210 via one or more switches.

Linear regulator 1310 may be considered to be a first stage circuit, while switched capacitor converter 1210 may be considered to be a second stage circuit. Although a linear regulator 1310 is shown in FIG. 13A, and shown as an LDO, in some embodiments a different type of linear regulator or other voltage regulation circuit (e.g., buck, boost, buck-boost, flyback) may be used in place of, or in addition to, linear regulator 1310, as discussed above with respect to FIG. 9. One skilled in the art would further appreciate that such regulators may be implemented as two distinct regulators, each connected to a different node of switched capacitor converter 1210 or as a single regulator with its single output selectively connected to different nodes of switched capacitor converter 1210 by way of switches.

The difference between the voltage applied by an energy source (e.g., energy source 510) and a regulated output voltage from a linear regulator (e.g., an LDO) may be proportional to the linear regulator's efficiency. Therefore, it may be desirable to minimize the difference between the voltage input to the linear regulator and the voltage output from the linear regulator. A linear regulator may be incapable of producing a regulated output voltage that is greater than its input voltage. When switch 1315 is turned on in system 1300 of FIG. 13A, then like with system 1100 of FIG. 11, the output of linear regulator 1310 is coupled to an input of first stage 1120 of switched capacitor converter 1210, to an input of second stage 1230 of switched capacitor converter 1230, and to an input of supply modulator 1260. In system 1300, the output of linear regulator 1310 may alternatively be coupled to node 1221 by turning switch 1320 on (instead of turning switch 1315 on).

As previously discussed, the voltage supplied by energy source 510 may vary, such as when energy source 510 comprises a battery. In system 1300, when the voltage supplied by energy source 510 is greater than a desired regulated voltage V_{R} switch 1315 may be turned on and may provide regulated voltage V_{R} at 945. When the voltage supplied by energy source 510 is lower than desired regulated voltage V_{R}, switch 1315 may be turned off and switch 1320 may be turned on, providing a regulated voltage at 1221. That is, when the voltage supplied by energy source 510 is lower than desired regulated voltage V_{R}, then by connecting (with switch 1320) the output of linear regulator 1310 to node 1221 instead of 945, linear regulator 1310 may be used in combination with second stage 1230 and/or first stage 1120 of switched capacitor converter 1210 to generate the desired regulated voltage V_{R}. Stated another way, the output of linear regulator 1310 may be input into switched capacitor converter 1210 at 1221, and switched capacitor converter 1210 may be used to boost the voltage to the desired regulated voltage V_{R} at 945. Thus, when the voltage supplied by energy source 510 is greater than the desired regulated voltage V_{R}, switch 1315 may be turned on so that linear regulator 1310 can provide the regulated voltage V_{R}, thereby improving efficiency by minimizing the power loss of the linear regulator. However, when the voltage supplied by energy source 510 is lower than the desired regulated voltage V_{R}, the desired regulated voltage V_{R} may still be achieved by using turning on switch 1320, thereby using switched capacitor converter 1210 to boost the voltage input to switched capacitor converter 1210 at 1221 to the regulated voltage V_{R} at 945.

FIG. 13B is a diagram of an example system 1365 utilizing a linear regulator and two stages of a switched capacitor converter to provide ratiometric supply levels, where a connection point of an output of the linear regulator to the switched capacitor converter can be reconfigured via switches, and where a driver stage of an amplifier is powered by one of the supply levels and a final stage of the amplifier is powered by another one of the supply levels. That is, system 1365 may be the same as system 1300, except that voltage 1223 (e.g., 2.4V from the example discussed above with respect to FIG. 13A) is used to supply a driver stage 1270 of an amplifier, and output V_{SUPPLY} (or Vout) 965 from supply modulator 1260 is used to supply a final stage 1280 of the amplifier. An RF signal (e.g., cellular or WiFi signal) 1275 may then be passed through driver stage 1270 and final stage 1280 and output as signal 1285.

Although use of multiple regulators connected to different connection points of a switched capacitor converter, or multiple switchable connection points from a linear regulator to a switched capacitor converter, were discussed above with respect to two stage switched capacitor converters, where a first stage is a voltage halver and the second stage outputs four voltages, the disclosure is not so limited. Use of multiple regulators connected to different connection points of a switched capacitor converter may be used with any configuration of a switched capacitor converter. Similarly, use of different switchable connection points from a linear regulator to a switched capacitor converter may be used with any configuration of a switched capacitor converter. The disclosure herein should not be limited to the specific examples of FIGS. 12A-13B.

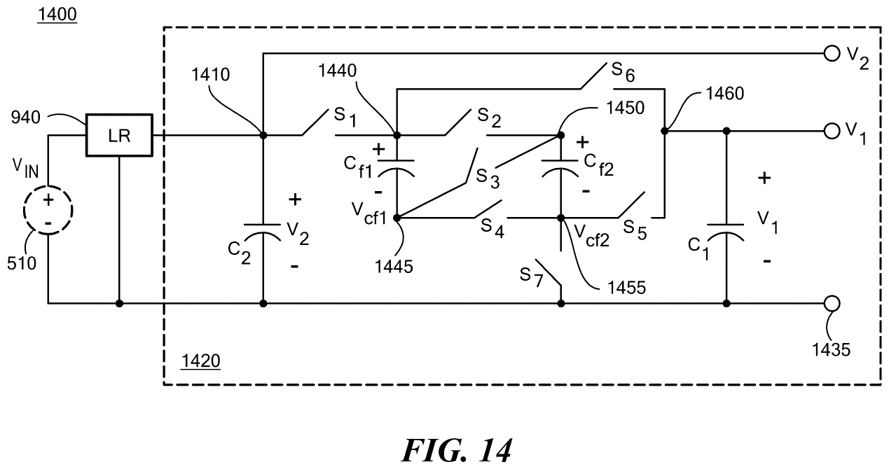

FIG. 14 is a diagram of a system 1400 utilizing one or more linear regulators (e.g., linear regulator 940) and one or more reconfigurable switched capacitor converters (e.g., reconfigurable switched capacitor converter 1420). System 1400 may be an example of a supply generator for supplying multiple voltages to a supply modulator (not shown).

Linear regulator 940 may be considered to be a first stage circuit, while reconfigurable switched capacitor converter 1420 may be considered to be a second stage circuit. Linear regulator 940 may be any type of linear regulator, such as an LDO as one example. Although a linear regulator 940 is shown in FIG. 14, in some embodiments different types of voltage regulation circuits may be used in place of, or in addition to, linear regulator 940. For example, a magnetic converter (e.g., buck, boost, buck-boost, flyback) may be used. Likewise, a switched capacitor converter with its output regulated by switching frequency and/or duty ratio may be used. As previously discussed, a linear regulator may have more dissipative loss than a magnetic converter (and thus be less efficient), but may be smaller in size (e.g., implemented on a small IC or with small components) and/or less expensive than a magnetic converter. Thus, use of a linear regulator may be advantageous in some applications, such as mobile applications, where size and/or cost may be a constraint.

Linear regulator 940 may output a regulated voltage V_{R}. The voltage level of V_{R} may be controllable by one or more controllers (e.g., controller(s) 915, such as previously discussed with respect to FIG. 9), as previously discussed. In some embodiments, the regulated voltage V_{R} may be adjusted in conjunction with a digital pre-distortion algorithm that provides pre-distortion for a modulated RF waveform. For example, one or more controllers implementing a DPD algorithm may send one or more signals to one or more controllers (e.g., controller(s) 915), and the one or more controllers receiving the one or more signals may control linear regulator 940 accordingly. In this way, the regulated voltage V_{R} may be adjusted to achieve a more optimal modulated RF performance, or to minimize loss. In some embodiments, the one or more controllers may control linear regulator 940, reconfigurable switched capacitor converter 1420, and/or a supply modulator (not shown). In some embodiments, the one or more controllers may control linear regulator 940, reconfigurable switched capacitor converter 1420, and/or a supply modulator (not shown) based on one or more signals received from one or more controllers implementing a DPD algorithm.

In the example of FIG. 14, a second stage circuit is realized as a reconfigurable switched capacitor converter 1420. Switched capacitor converter 1420 may be referred to as a reconfigurable series-parallel switched capacitor converter. In some embodiments, switched capacitor converter 1420 may be used to implement switched capacitor converter 720 of system 700, switched capacitor converter 950 of system 900, switched capacitor converter 1050 of system 1000, or a stage of switched capacitor converter 1110 of system 1100 or of switched capacitor converter 1210 (of system 1200, 1265, 1300, or 1365).

Reconfigurable switched capacitor converter 1420 comprises a hold up capacitor C₂ coupled between a node 1410 at the output of linear regulator 940 and ground, configured to hold up a voltage V₂ (equal to V_{R}), and a hold up capacitor C₁ coupled between a node 1460 and ground, configured to hold up a voltage V₁. Reconfigurable switched capacitor converter 1420 also comprises seven switches, a first switch S₁ coupled between a node 1410 and a node 1440, a second switch S₂ coupled between a node 1440 and a node 1450, a third switch S₃ coupled between a node 1445 and node 1450, a fourth switch S₄ coupled between node 1445 and a node 1455, a fifth switch S₅ coupled between node 1455 and node 1460, a sixth switch S₆ coupled between node 1440 and node 1460, and a seventh switch S₇ coupled between node 1455 and ground. Reconfigurable switched capacitor converter 1420 further comprises a flying capacitor C_{f1} coupled between node 1440 and 1445, configured to hold a voltage V_{cf1}, and a flying capacitor C_{f2} coupled between node 1450 and node 1455, configured to hold a voltage V_{cf2}.

In system 1400, linear regulator 940 outputs a regulated voltage V_{R}, which is output as an output voltage V₂ (corresponding to the voltage at node 1410). Another output voltage V₁ (corresponding to the voltage at node 1460) may be synthesized as V₁=(⅔)*V₂ or V₁=(½)*V₂, depending on the selected operating mode of reconfigurable switched capacitor converter 1420. It is also noted that by regulating the switching frequency and/or duty ratio of the switches, one may regulate the output V₁ to be maintained at a desired value below (⅔)*V₂ or below (½)*V₂ depending on the selected operating mode of reconfigurable switched capacitor converter 1420.

A person of ordinary skill in the art would recognize that controllers typically control power supplies at an operating frequency, where a switching cycle corresponds to a period at that operating frequency, and where switches may be controlled in one of two phases (e.g., portions) of a switching cycle, wherein one phase takes up approximately a fraction D (the duty ratio) of the whole switching cycle.

In a first operating mode, one or more controllers (e.g., controller(s) 915, as previously discussed with respect to FIG. 9) may control the switches of reconfigurable switched capacitor converter 1420 to output V₁ at a level that is (⅔)*V₂. For example, in a first phase of a switching cycle, the one or more controllers may control switches S₁, S₂, S₄, and S₅ to be on (with switches S₃, S₆, and S₇ off). In a second phase of the switching cycle, the one or more controllers may control switches S₃, S₆, and S₇ to be on (with switches S₁, S₂, S₄, and S₅ off). Controlling the switches of reconfigurable switched capacitor converter 1420 in this fashion may result in an output voltage V₁ that is (⅔)*V₂. By controlling the switching frequency and/or controlling the relative duty cycle of the two phases, one may achieve a regulated output V₁ that is a specified value below (⅔)*V₂.

In a second operating mode, the one or more controllers (e.g., controller(s) 915) may control the switches of reconfigurable switched capacitor converter 1420 to output V₁ at a level that is (½)*V₂. For example, in a first phase of a switching cycle, the one or more controllers may control switches S₁, S₂, S₄, and S₅ to be on (with switches S₃, S₆, and S₇ off). In a second phase of the switching cycle, the one or more controllers may control switches S₂, S₄, S₆, and S₇ to be on (with switches S₁, S₃, and S₅ off). Controlling the switches of reconfigurable switched capacitor converter 1420 in this fashion may result in an output voltage V₁ that is (½)*V₂. By controlling the switching frequency and/or controlling the relative duty cycle of the two phases, one may achieve a regulated output voltage V₁ that is a specified value below (½)*V₂.

The output voltages of system 1400 may be output to a supply modulator, which may select from the output voltages to provide a selected voltage as a supply voltage V_{SUPPLY} to a PA. Thus, in a first operating mode, a supply modulator connected to system 1400 may select between voltages V₂ (equal to V_{R}), V₁ (equal to (⅔)*V₂ or (½)*V₂, depending on operating mode) and optionally 0V (where the ground terminal of energy source 510 is coupled to the supply modulator.

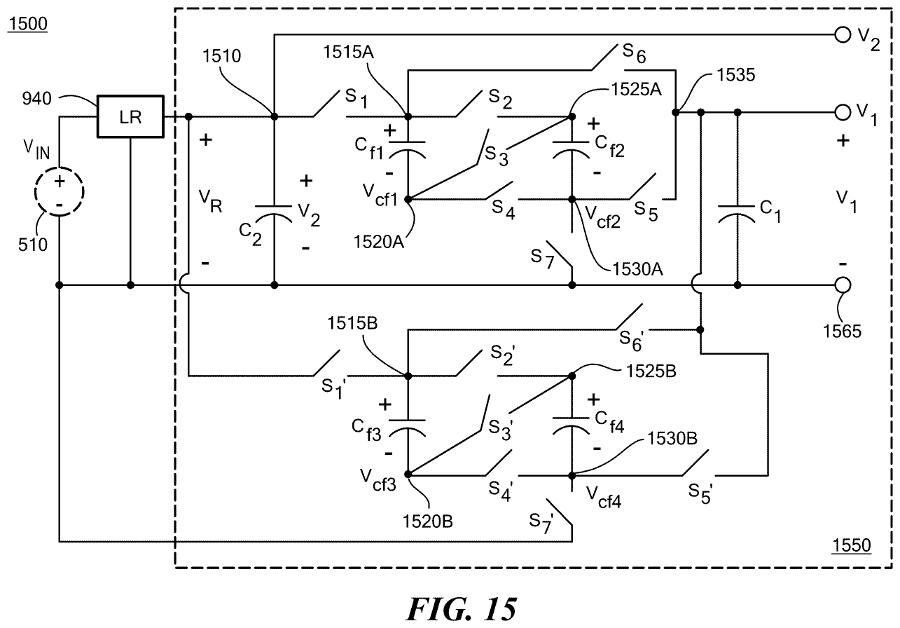

FIG. 15 is a diagram of a system 1500 utilizing one or more linear regulators (e.g., linear regulator 940) and one or more reconfigurable switched capacitor converters (e.g., reconfigurable switched capacitor converter 1550). System 1500 may be an example of a supply generator for supplying multiple voltages to a supply modulator (not shown). Reconfigurable switched capacitor converter 1550 may be an example of an interleaved version of reconfigurable switched capacitor converter 1420 (e.g., series-parallel converter). Use of an interleaved version of reconfigurable switched capacitor converter 1420, as shown in switched capacitor converter 1550 of system 1500, may provide similar functionality to reconfigurable switched capacitor converter 1420 while reducing the requirements on the sizes of capacitors C₁ and C₂ of that converter.

Linear regulator 940 may be considered to be a first stage circuit, while reconfigurable switched capacitor converter 1550 may be considered to be a second stage circuit. Linear regulator 940 may be any type of linear regulator, such as an LDO as one example. Although a linear regulator 940 is shown in FIG. 15, in some embodiments different types of voltage regulation circuits may be used in place of, or in addition to, linear regulator 940. For example, a magnetic converter (e.g., buck, boost, buck-boost, flyback) may be used or a regulated switched-capacitor converter, a regulated hybrid magnetic switched-capacitor converter, or a piezoelectric-based converter may be used. As previously discussed a linear regulator may have more dissipative loss than a magnetic converter (and thus be less efficient), but may be smaller in size (e.g., implemented on a small IC or with small components) and/or less expensive than a magnetic converter. Thus, use of a linear regulator may be advantageous in some applications, such as mobile applications, where size and/or cost may be a constraint.

Linear regulator 940 may output a regulated voltage V_{R}. The voltage level of V_{R} may be controllable by one or more controllers (e.g., controller(s) 915, such as previously discussed with respect to FIG. 9), as previously discussed. In some embodiments, the regulated voltage V_{R} may be adjusted in conjunction with a digital pre-distortion algorithm that provides pre-distortion for a modulated RF waveform. For example, one or more controllers implementing a DPD algorithm may send one or more signals to one or more controllers (e.g., controller(s) 915), and the one or more controllers receiving the one or more signals may control linear regulator 940 accordingly. In this way, the regulated voltage V_{R} may be adjusted to achieve a more optimal modulated RF performance, or to minimize loss. In some embodiments, the one or more controllers may control linear regulator 940, reconfigurable switched capacitor converter 1550, and/or a supply modulator (not shown). In some embodiments, the one or more controllers may control linear regulator 940, reconfigurable switched capacitor converter 1550, and/or a supply modulator (not shown) based on one or more signals received from one or more controllers implementing a DPD algorithm.

In the example of FIG. 15, a second stage circuit is realized as an interleaved reconfigurable switched capacitor converter 1550. Switched capacitor converter 1550 may be referred to as an interleaved reconfigurable series-parallel switched capacitor converter. In some embodiments, interleaved switched capacitor converter 1550 may be used to implement switched capacitor converter 720 of system 700, switched capacitor converter 950 of system 900, switched capacitor converter 1050 of system 1000, or a stage of switched capacitor converter 1110 of system 1000 or of switched capacitor converter 1210 (of system 1200, 1265, 1300, or 1365).

Interleaved reconfigurable switched capacitor converter 1550 comprises a hold up capacitor C₂ coupled between a node 1510 at the output of linear regulator 940 and ground 1565, configured to hold up a voltage V₂ (equal to V_{R}), and a hold up capacitor C₁ coupled between a node 1535 and ground 1565, configured to hold up a voltage V₁. Interleaved reconfigurable switched capacitor converter 1550 also comprises seven switches (S₁, S₂, S₃, S₄, S₅, S₆, S₇) and two capacitors (C_{f1}, C_{f2}) in one portion of the converter, and seven switches (S₁′, S₂′, S₃′, S₄′, S₅′, S₆′, S₇′) and two capacitors (C_{f3}, C_{f4}) in another portion of the converter. A first switch S₁ of the first portion is coupled between a node 1510 and a node 1515A, a second switch S₂ of the first portion is coupled between a node 1515A and a node 1525A, a third switch S₃ of the first portion is coupled between a node 1520A and node 1525A, a fourth switch S₄ of the first portion is coupled between node 1520A and a node 1530A, a fifth switch S₅ of the first portion is coupled between node 1530A and a node 1535, a sixth switch S₆ is coupled between node 1515A and node 1535, and a seventh switch S₇ is coupled between node 1530A and ground 1565. The first portion of interleaved reconfigurable switched capacitor converter 1550 further comprises a flying capacitor C_{f1} coupled between node 1515A and node 1520A, configured to hold a voltage V_{cf1}, and a flying capacitor C_{f2} coupled between node 1525A and node 1530A, configured to hold a voltage V_{cf2}.

A first switch S₁′ of the second portion is coupled between node 1510 and a node 1515B, a second switch S₂′ of the second portion is coupled between node 1515B and a node 1525B, a third switch S₃′ of the second portion is coupled between a node 1520B and node 1525B, a fourth switch S₄′ of the second portion is coupled between node 1520B and a node 1530B, a fifth switch S₅′ of the second portion is coupled between node 1530B and node 1535, a sixth switch S₆′ of the second portion is coupled between node 1515B and node 1535, and a seventh switch S₇′ of the second portion is coupled between node 1530B and ground 1565. The second portion of interleaved reconfigurable switched capacitor converter 1550 also comprises a flying capacitor C_{f3} coupled between node 1515B and node 1520B, configured to hold a voltage V_{cf3}, and a flying capacitor C_{f4} coupled between node 1525B and node 1530B, configured to hold a voltage V_{cf4}.

In system 1500, linear regulator 940 outputs a regulated voltage V_{R}, which is output as an output voltage V₂ (corresponding to the voltage at node 1510). Another output voltage V₁ (corresponding to the voltage at node 1535) may be synthesized as V₁=(⅔)*V₂ or V₁=(½)*V₂, depending on the selected operating mode of interleaved reconfigurable switched capacitor converter 1550. It is also noted that by regulating the switching frequency and/or duty ratios of the switches, one may regulate the output voltage V₁ to be maintained at a desired value below (⅔)*V₂ or below (½)*V₂ depending on the selected operating mode of interleaved reconfigurable switched capacitor converter 1550.

In a first operating mode, one or more controllers (e.g., controller(s) 915) may control the switches of interleaved reconfigurable switched capacitor converter 1550 to output V₁ at a level that is (⅔)*V₂. For example, in a first phase of a switching cycle, the one or more controllers may control switches S₁, S₂, S₄, S₅, S₃′, S₆′, and S₇′ to be on (with switches S₃, S₆, S₇, S₁′, S₂′, S₄′, and S₅′ off). In a second phase of the switching cycle, the one or more controllers may control switches S₃, S₆, S₇, S₁′, S₂′, S₄′, and S₅′ to be on (with switches S₁, S₂, S₄, S₅, S₃′, S₆′ and S₇′ off). Controlling the switches of interleaved reconfigurable switched capacitor converter 1550 in this fashion may result in an output voltage V₁ that is (⅔)*V₂. By controlling the switching frequency and/or controlling the relative duty cycle of the two phases, one may achieve a regulated output voltage V₁ that is a specified value below (⅔)*V₂.

In a second operating mode, the one or more controllers (e.g., controller(s) 915) may control the switches of interleaved reconfigurable switched capacitor converter 1550 to output V₁ at a level that is (½)*V₂. For example, in a first phase of a switching cycle, the one or more controllers may control switches S₁, S₂, S₄, S₅, S₂′, S₄′, S₆′, and S₇′ to be on (with switches S₃, S₆, S₇, S₁′, S₃′ and S₅′ off). In a second phase of the switching cycle, the one or more controllers may control switches S₂, S₄, S₆, S₇, S₁′, S₂′, S₄′, and S₅′ to be on (with switches S₁, S₃, S₅, S₃′, S₆′ and S₇′ off). Controlling the switches of interleaved reconfigurable switched capacitor converter 1550 in this fashion may result in an output voltage V₁ that is (½)*V₂. By controlling the switching frequency and/or controlling the relative duty cycle of the two phases, one may achieve a regulated output voltage V₁ that is a specified value below (½)*V₂.

The output voltages of system 1500 may be output to a supply modulator, which may select from the output voltages to provide a selected voltage as a supply voltage V_{SUPPLY} to a PA. Thus, in a first operating mode, a supply modulator connected to system 1500 may select between voltages V₂ (equal to V_{R}), V₁ (equal to (⅔)*V₂ or (½)*V₂, depending on operating mode) and optionally 0V (where the ground terminal of energy source 510 is coupled to the supply modulator.

As previously discussed, interleaved reconfigurable switched capacitor converter 1550 of FIG. 15 provides similar functionality to that of reconfigurable switched capacitor converter 1420 of FIG. 14, while reducing the requirements on the sizes of capacitors C₁ and C₂. Thus, capacitors C₁ and C₂ may be smaller in size for interleaved reconfigurable switched capacitor converter 1550 than for reconfigurable switched capacitor converter 1420, with the tradeoff being that more components (e.g., capacitors, switches) may be required to implement an interleaved version of the reconfigurable switched capacitor converter.

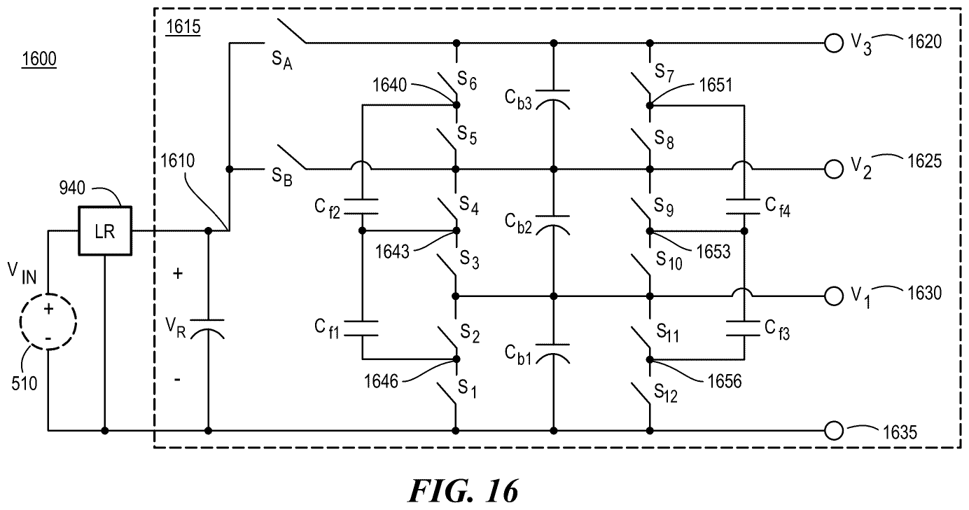

FIG. 16 is a diagram of a system 1600 utilizing one or more linear regulators (e.g., linear regulator 940) and one or more reconfigurable switched capacitor converters (e.g., reconfigurable switched capacitor converter 1615). System 1600 may be an example of a supply generator for supplying multiple voltages to a supply modulator (not shown). Reconfigurable switched capacitor converter 1615 may be an example of a reconfigurable interleaved ladder switched capacitor converter. Reconfigurable interleaved ladder switched capacitor converter 1615 may be reconfigured by changing the connection of the output V_{R} of linear regulator 940 to the switched capacitor ladder converter.

Linear regulator 940 may be considered to be a first stage circuit, while reconfigurable interleaved ladder switched capacitor converter 1615 may be considered to be a second stage circuit. Linear regulator 940 may be any type of linear regulator, such as an LDO as one example. Although a linear regulator 940 is shown in FIG. 16, in some embodiments different types of voltage regulation circuits may be used in place of, or in addition to, linear regulator 940. For example, a magnetic converter (e.g., buck, boost, buck-boost, flyback) may be used, a regulated switched capacitor converter may be used, a regulated hybrid magnetic/switched capacitor converter may be used, or a piezoelectric-based power converter may be used. As previously discussed, a linear regulator may have more dissipative loss than a magnetic converter (and thus be less efficient), but may be smaller in size (e.g., implemented on a small IC or with small components) and/or less expensive than a magnetic converter. Thus, use of a linear regulator may be advantageous in some applications, such as mobile applications, where size and/or cost may be a constraint.

Linear regulator 940 may output a regulated voltage V_{R}. The voltage level of V_{R} may be controllable by one or more controllers (e.g., controller(s) 915, such as previously discussed with respect to FIG. 9), as previously discussed. In some embodiments, the regulated voltage V_{R} may be adjusted in conjunction with a digital pre-distortion algorithm that provides pre-distortion for a modulated RF waveform. For example, one or more controllers implementing a DPD algorithm may send one or more signals to one or more controllers (e.g., controller(s) 915), and the one or more controllers receiving the one or more signals may control linear regulator 940 accordingly. In this way, the regulated voltage V_{R} may be adjusted to achieve a more optimal modulated RF performance, or to minimize loss. In some embodiments, the one or more controllers may control linear regulator 940, reconfigurable interleaved ladder switched capacitor converter 1615, and/or a supply modulator (not shown). In some embodiments, the one or more controllers may control linear regulator 940, reconfigurable interleaved ladder switched capacitor converter 1615, and/or a supply modulator (not shown) based on one or more signals received from one or more controllers implementing a DPD algorithm.

In the example of FIG. 16, a second stage circuit is realized as a reconfigurable switched capacitor converter 1615. Switched capacitor converter 1615 may be referred to as a reconfigurable interleaved ladder switched capacitor converter 1615. In some embodiments, reconfigurable interleaved ladder switched capacitor converter 1615 may be used to implement switched capacitor converter 720 of system 700, switched capacitor converter 950 of system 900, switched capacitor converter 1050 of system 1000, or a stage of switched capacitor converter 1110 of system 1000 or of switched capacitor converter 1210 (of system 1200, 1265, 1300, or 1365).

Reconfigurable interleaved ladder switched capacitor converter 1615 comprises hold up capacitors C_{b1}, C_{b2}, and C_{b3} coupled in a stacked fashion between a voltage V₃ 1620 and a ground voltage 1635. That is, capacitor C_{b1} is coupled between a voltage V₁ 1630 and a ground voltage 1635, capacitor C_{b2} is coupled between a voltage V₂ 1625 and voltage V₁ 1630, and capacitor C_{b3} is coupled between a voltage V₃ 1620 and voltage V₂ 1625. Reconfigurable interleaved ladder switched capacitor converter 1615 also comprises a hold up capacitor coupled between node 1610 and ground voltage 1635, and configured to hold up voltage V_{R} output from linear regulator 940.

Reconfigurable interleaved ladder switched capacitor converter 1615 further comprises twelve switches, a first switch S₁ coupled between a node 1646 and ground voltage 1635, a second switch S₂ coupled between voltage V₁ 1630 and node 1646, a third switch S₃ coupled between a node 1643 and voltage V₁ 1630, a fourth switch S₄ coupled between voltage V₂ 1625 and node 1643, a fifth switch coupled between a node 1640 and voltage V₂ 1625, a sixth switch S₆ coupled between voltage V₃ and node 1640, a seventh switch S₇ coupled between voltage V₃ 1620 and a node 1651, an eight switch S₈ coupled between node 1651 and voltage V₂ 1625, a ninth switch S₉ coupled between voltage V₂ 1625 and a node 1653, a tenth switch S₁₀ coupled between node 1653 and voltage V₁ 1630, an eleventh switch S₁₁ coupled between voltage V₁ 1630 and a node 1656, and a twelfth switch S₁₂ coupled between node 1656 and ground voltage 1635.

Reconfigurable interleaved ladder switched capacitor converter 1615 further comprises four flying capacitors, C_{f1}, C_{f2}, C_{f3}, and C_{f4}. Flying capacitor C_{f1} is coupled between node 1643 and node 1646, flying capacitor C_{f2} is coupled between node 1640 and node 1643, flying capacitor C_{f3} is coupled between node 1653 and node 1656, and flying capacitor C_{f4} is coupled between node 1651 and node 1653.

Reconfigurable interleaved ladder switched capacitor converter 1615 also comprises two switches for changing a connection between the output V_{R} of linear regulator 940 and reconfigurable interleaved ladder switched capacitor converter 1615, switches S_{A} and S_{B}. For example, as shown in FIG. 16, switch S_{A}, when on, may couple the output V_{R} of linear regulator 940 as voltage V₃ 1620. Switch S_{B}, when on, may couple the output V_{R} of linear regulator 940 as voltage V₂ 1625. Thus, one or more controllers (e.g., controller(s) 915) may control switches S_{A} and S_{B} to reconfigure a connection point at which the output V_{R} of linear regulator 940 enters reconfigurable interleaved ladder switched capacitor converter 1615.

For reconfigurable interleaved ladder switched capacitor converter 1615, in each operating mode, odd numbered switches (S₁, S₃, S₅, S₇, S₉, S₁₁) of reconfigurable interleaved ladder switched capacitor converter 1615 are turned on (with even numbered switches turned off) in a first phase of a switching cycle, and even numbered switches (S₂, S₄, S₆, S₈, S₁₀, S₁₂) of reconfigurable interleaved ladder switched capacitor converter 1615 are turned on (with odd numbered switched turned off) in a second phase of the switching cycle. In a first operating mode, switch S_{A} is held on, such that voltage V₃ 1620 equals V_{R}, with voltage V₂ 1625 equal to (⅔)*V_{R}, and with voltage V₁ 1630 equal to (⅓)*V_{R}. In a second operating mode, switch S_{B} is held on, such that voltage V₂ equals V_{R}, with voltage V₃ equaling (3/2)*V_{R} and voltage V₁ equaling (½)*V_{R}. Thus, the second operating mode may provide a voltage V₃ that is boosted from the regulated output voltage V_{R} of linear regulator 940. Such a boost voltage may be advantageous when, for example, a voltage level of an energy source, such as a battery, has lowered such that it can no longer be used to power a PA, but where the boosted voltage may provide enough voltage to power the PA for a period of time.

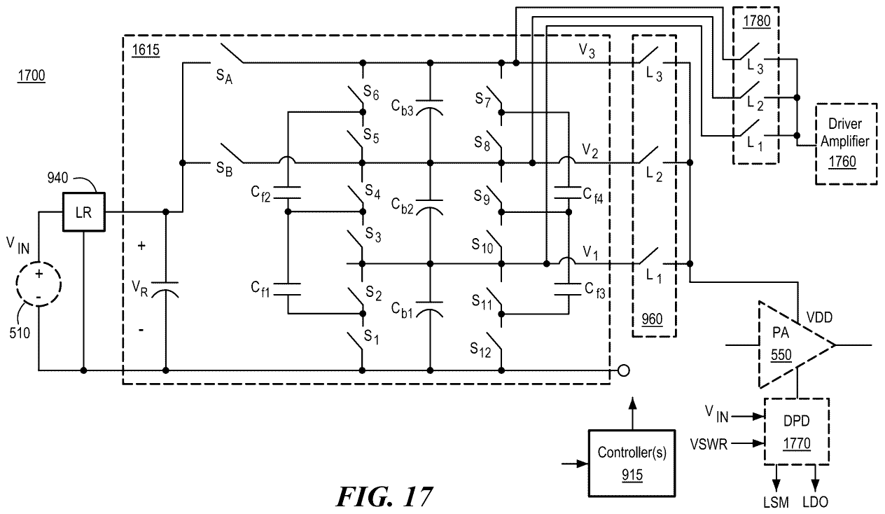

FIG. 17 is a diagram of an example system 1700 that may be used for supplying power to one or more amplifiers (e.g., PA 550, driver amplifier 1760). System 1700 may utilize one or more linear regulators (e.g., linear regulator 940), one or more switched capacitor converters (e.g., switched capacitor converter 1615), one or more supply modulators (e.g., supply modulator 960, supply modulator 1780), and one or more controllers (e.g., controller(s) 915, such as previously discussed with respect to FIG. 9). As shown in FIG. 17, one or more controllers 1770 implementing a DPD algorithm may be coupled to a PA 550. Switched capacitor converter 1615 may be the same switched capacitor as shown and described with respect to FIG. 16, though the disclosure is not so limited.

System 1700 may be utilized to provide a supply voltage of a certain value to an amplifier (e.g., PA 550, driver amplifier 1760) even as the voltage of an energy source 510 (e.g., battery) varies. For example, PA 550 and/or driver amplifier 1760 may be implemented as a stacked PA, such as a stacked CMOS SOI UC12 RF PA. Assume, for example, that PA 550 and/or drive amplifier 1760 requires a drain voltage supply of 4.5V in order to operate. Assume also that the voltage of energy source 510 (e.g., battery) varies between 3V and 5V. Using system 1700, a supply voltage of 4.5V may be provided to PA 550 and/or driver amplifier 1760 even when the voltage of energy source 510 is at 3V. For example, as previously discussed with respect to FIG. 16, switched capacitor converter 1615 may be controlled in an operating mode to generate a voltage of (3/2)*V_{R}, such that when V_{R} is 3V, an output voltage V₃ may be 4.5V.

Controller(s) 1770 may receive signals representing one or more characteristics of system 1700, such as the voltage V_{IN} from energy source 510 and/or a voltage standing wave ratio (VSWR) of an RF power amplifier system. Controller(s) 1770 may output one or more signals to linear regulator 940 (e.g., LDO) or to controller(s) 915 for controlling one or more voltage set points of linear regulator 940 so as to output a desired regulated voltage VSC (voltage to switched capacitor converter, or V_{R}) from linear regulator 940 to switched capacitor converter(s) 1615. Controller(s) 915 may control switches of switched capacitor converter 1615 to configure switched capacitor converter 1615 into a desired operating mode. Controller(s) 915 and/or controller(s) 1770 may also output one or more level supply modulator (LSM) or DCL signals to control supply modulator 960 to select one of a plurality of voltage levels from switched capacitor converter 1615 to provide to an amplifier (e.g., PA 550, driver amplifier 1760).

Controller(s) 1770 and/or controller(s) 915 may control linear regulator 940, switched capacitor converter 1615, and/or supply modulator 960 to change operation as the voltage of energy source 510 (e.g., battery) varies, so as to optimize losses. For example, Table 2 below shows three configurations that may achieve an output voltage of 4.5V to a final stage PA (e.g., PA 550). The linear regulator 840, switched capacitor converter 1615, and/or supply modulator 960 may be controlled with an adaptive power tracking (APT) technique, such that switched capacitor converter 1615 has time to be reconfigured with changes in average output power (and required voltage to PA 550) or with changes in voltage of energy source 510.

TABLE 2

| V_{IN} | VLR (V_{IN} − V_{R}) | V_{R} | LSM | VDD |
|---|---|---|---|---|
| 5 | 0.5 | 4.5 | 3 | 4.5 |
| 3.8 | 0.8 | 3.0 | 3 | 4.5 |
| 3.15 | 0.15 | 3.0 | 3 | 4.5 |

In Table 2, VIN corresponds to the voltage of the energy source 510, VLR corresponds to the voltage drop in linear regulator 940 (e.g., V_{IN}-V_{R}), V_{R} corresponds to the voltage from linear regulator 940 input to the switched capacitor converter (e.g., switched capacitor converter 1615), LSM corresponds to a level of the ladder in switched capacitor converter 1615 selected by a supply modulator (e.g., supply modulator 960), and VDD corresponds to the voltage at the level of the ladder in switched capacitor converter 1615 selected by a supply modulator and supplied to an amplifier (e.g., PA 550).

For example, as shown in Table 2, at V_{IN} of 5V (e.g., highest V_{IN} or charging voltage), linear regulator 840 may be controlled such that losses are minimized (e.g., at 0.5V), and such that the voltage output of linear regulator (V_{R}) to the switched capacitor converter is 4.5V. Switch S_{A} may be held on and supply modulator level L₃ selected by supply modulator 960, so as to output a voltage of 4.5V (5V of V_{IN}-0.5 V VLR) to a power amplifier (e.g., PA 550).

When V_{IN} is 3.8V, for example, linear regulator 940 may be controlled such that losses are minimized (e.g., at 0.8V), and such that the voltage output of linear regulator (VSC) to the switched capacitor converter is 3.0V. Switch S_{B} may be held on, such that voltage V₂ equals V_{R}, with voltage V₃ equaling (3/2)*V_{R} (as discussed above with respect to FIG. 16). Supply modulator level L₃ may then be selected by supply modulator 960, so as to output a voltage of 4.5V ((3.8V of V_{IN}-0.8V VLR)*(3/2)).

When V_{IN} is 3.15V, for example, linear regulator 940 may be controlled such that losses are minimized (e.g., at 0.15V), and such that the voltage output of linear regulator (V_{R}) to the switched capacitor converter is 3.0V. Switch S_{B} may be held on, such that voltage V₂ equals V_{R}, with voltage V₃ equaling (3/2)*V_{R} (as discussed above with respect to FIG. 16). Supply modulator level L₃ may then be selected by supply modulator 960, so as to output a voltage of 4.5V ((3.15V of V_{IN}-0.15V VLR)*(3/2)).

In some embodiments, system 1700 may be configured to supply voltages to multiple amplifiers, such as both PA 550 (e.g., output stage of the RF amplifier) and driver amplifier 1760 (e.g., driver stage of the RF amplifier). Driver amplifier 1760 may operate at a lower voltage than PA 550, or at a high voltage (e.g., 4.5V) like PA 550. In some embodiments, a second supply modulator 1780 may be provided in system 1700, which may be controlled (e.g., by controller(s) 1770 and/or controller(s) 915) to select one of the output voltages generated by switched capacitor converter 1615 for providing to driver amplifier 1760. Thus, by providing two different supply modulators, PA 550 may be supplied with a first voltage of the voltages generated by switched capacitor converter 1615 (and selected by supply modulator 960), while driver amplifier 1760 may be supplied with a second, different voltage of the voltages generated by switched capacitor converter 1615 (and selected by supply modulator 1780). In some embodiments, driver amplifier 1760 may be one stage of a multiple stage amplifier and PA 550 may be another stage of a multiple stage amplifier, such that supply modulator 960 may select a first voltage to supply to one stage of the multiple stage amplifier and supply modulator 1780 may select a second voltage to supply to another stage of the multiple stage amplifier.

In some embodiments, one of the multiple amplifiers (e.g., PA 550, driver amplifier 1760) may be directly coupled to a voltage level of switched capacitor converter 1615 (i.e., without a supply modulator coupled between the voltage level of switched capacitor converter 1615 and the amplifier) while the other of the multiple amplifiers (e.g., PA 550, driver amplifier 1760) may be coupled to a supply modulator (e.g., supply modulator 960, supply modulator 1780) that is coupled to the voltage levels of the switched capacitor converter.

Controller(s) 1770 implementing a DPD algorithm may receive one or more signals representing a voltage standing wave ratio (VSWR) related to how efficiently RF power is being transmitted by one or more amplifiers, and/or may receive one or more signals representing a voltage level output by energy source 510 (e.g., battery). Controller(s) 1770 may utilize information in these signals to adjust predistortion of an RF signal being input to one or more amplifiers to maintain linearity, and so that linear regulator 940, switched capacitor converter 1615, and/or supply modulator 960 may be reconfigured based on a required voltage (e.g., VDD in an APT mode, required L3 VDD) and to modify one or more control signals (e.g., DCL signal(s) in a digital envelope tracking (ET) mode) output by controller(s) 1770.

The DPD algorithm may include logic that determines the VDD voltage level that should be used for a final stage of an amplifier, a driver stage of an amplifier, and/or other stages of an amplifier based on characteristics such as VSWR, input voltage V_{IN}, temperature, output power Pₒᵤₜ, and/or other characteristics. The logic may create a level select signal for use in controlling a supply modulator (e.g., supply modulator 960, supply modulator 1780). Alternatively, the logic may create a signal it sends to one or more other controllers (e.g., controller(s) 915) that then control a supply modulator based on the received signal. The DPD algorithm may apply predistortion (e.g., creating “X” from “R”) to an RF signal input to an RF amplifier (e.g., an l/Q signal) based on information regarding what a system's nonlinearity may be at a given VDD voltage level. The logic may also create control signals for supply generation (e.g., for regulators, voltage adder or subtractors, switched capacitor converters) to generate output voltages at desired levels, and may either control supply generation components directly or send the signals to one or more other controllers (e.g., controller(s) 915) to cause the one or more other controllers to control the supply generation components.

In some embodiments, a supply modulator 860 may comprise two supply modulators, where each of the supply modulators are coupled via a pulse-shaping networking (PSN) to a single RF amplifier. Techniques for implementing such a PSN are discussed in U.S. Patent Application Publication No. 2024/0136991, titled “Pulse-Shaping Networks with Coupled Magnets,” which is commonly assigned and is hereby incorporated by reference herein in its entirety.

Various embodiments of the concepts, systems, circuits, devices, methods, and techniques sought to be protected are described herein with reference to the related drawings. Alternative embodiments may be devised without departing from the scope of the concepts, systems, circuits, devices, methods, and techniques described herein. It is noted that various connections and positional relationships (e.g., over, below, adjacent, etc.) may be set forth between elements in the foregoing description and in the drawings. These connections and/or positional relationships, unless specified otherwise, may be direct or indirect, and the described concepts, systems, circuits, devices, methods, and techniques are not intended to be limited in this respect. Accordingly, a coupling of components or subsystems may refer to either a direct or an indirect coupling, and a positional relationship between components or subsystems may be a direct or indirect positional relationship.

FIGS. 1A-17 illustrate circuits with certain components directly connected to one another. A person of ordinary skill in the art would understand that each of these components has terminals by which they may be connected with the other components over wires, electrical traces, or other conductive lines as shown in the schematic drawings. While FIGS. 1A-17 may illustrate certain components as being directly connected to one another, the disclosure is not so limited. One or more components may, for example, be connected between the components illustrated as being directly connected in the schematic drawings of FIGS. 1A-17. Both direct connections and indirect connections are intended to be encompassed by the disclosure herein. When direct connections are meant herein and in the claims, the word “direct” will be used in connoting the connection between the components. Thus, the term “connection” (or any variant thereof), may include an “indirect connection” or a “direct connection.”

As used herein, the terms “comprises,” “comprising,” “includes,” “including,” “has,” “having,” contains,” “containing,” or any other variation thereof, are intended to cover a non-exclusive inclusion. For example, a system, system architecture, subsystem, component, circuit, process, method, article, device, or apparatus that comprises a list of elements or steps is not necessarily limited to only those elements or steps but may include other elements or steps not expressly listed or inherent to such system, system architecture, subsystem, component, circuit, process, method, article, device, or apparatus.

Additionally, the term “exemplary,” if used herein, means “serving as an example, instance or illustration.” Any embodiment or example described herein as “exemplary” is not necessarily to be construed as preferred or advantageous over other embodiments or designs. The terms “one or more” is understood to include any integer number greater than or equal to one, i.e., one, two, three, four, etc. The term “plurality” is understood to include any integer number greater than or equal to two, i.e., two, three, four, five, etc.

References in the specification to “one embodiment,” “an embodiment,” “an example embodiment,” etc., indicate that the embodiment may include a particular feature, structure, or characteristic, but every embodiment may include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described in that manner.

Use of ordinal terms, such as “first, second,” “third,” etc., in the claims to modify a claim element does not by itself connote any priority, preference, or order of one claim element over another, or the temporal order in which acts of a method are performed, but are used merely as labels to distinguish one claim element having a certain name from another element having a same name (but for use of the ordinal term) to distinguish the claim elements.

The terms “approximately,” substantially or “about” may be used to mean±/−30% of a target value in some embodiments, within +/−20% of a target value in some embodiments, within +/−10% of a target value in some embodiments, within +/−5% of a target value in some embodiments, and within +/−2% of a target value in some embodiments. The aforementioned terms may include the target value. The terms “approximately equal to,” substantially equal to” or “about equal to” may be used to refer to values that are within +/−30% of one another in some embodiments, within +/−20% of one another in some embodiments, within +/−10% of one another in some embodiments, within +/−5% of one another in some embodiments, and within +/−2% of one another in some embodiments. For example, a first voltage value that is “approximately,” “substantially,” or about equal to a second voltage value may within +/−30% of the second voltage value in some embodiments, within +/−20% of the second voltage value in some embodiments, within +/−10% of the second voltage value in some embodiments, within +/−5% of the second voltage value in some embodiments, or within +/−2% of the second voltage value in some embodiments. The aforementioned terms may exact matching of values.

It is to be understood that components used in electronic are lossy. Values described herein are described as ideal values and assume lossless components. As a result, descriptions of values, such as voltage values, or use of the phrase “equal to” herein, should be considered to include values within +/−10% of the value indicated.

It is to be understood that the disclosed subject matter is not limited in its application to the details of construction and to the arrangement of the components set forth in the foregoing description or illustrated in the drawings. The disclosed subject matter is capable of other embodiments and of being practiced and carried out in various ways.

Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, systems, system architectures, circuits, methods, and techniques for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing example embodiments, it is to be understood that the present disclosure has been made only by way of example, and that numerous changes in the details of implementation of the disclosed subject matter may be made without departing from the spirit and scope of the disclosed subject matter.

1. A system having a pair of input terminals configured to be connected to terminals of an energy source and having a pair of output terminals configured to be connected to a radio frequency (RF) amplifier, the system comprising:
a linear regulator configured to draw power at the input terminals and to output a regulated voltage;
a switched capacitor converter coupled to the output of the linear regulator; and
a supply modulator coupled to the output of the switched capacitor converter.

2. The system of claim 1, further comprising a controller and a digital interface coupled between the controller and at least one of the linear regulator or the switched capacitor converter and used to modify operation of at least one of the linear regulator or switched capacitor converter.

3. The system of claim 1, further comprising a controller and a digital interface coupled between the controller and the supply modulator, wherein the controller is configured to control the supply modulator via the digital interface.

4. The system of claim 1, wherein the switched capacitor converter is reconfigurable.

5. The system of claim 1, wherein at least one of the switched capacitor converter, the regulated voltage output from the linear regulator, or a connection point between the linear regulator and the switched capacitor converter is reconfigurable.

6. The system of claim 1, wherein the linear regulator is one of a plurality of linear regulators having different connection points to the switched capacitor converter, wherein which of the linear regulators actively regulates its output is reconfigurable.

7. The system of claim 4, wherein the switched capacitor converter is reconfigured by changing its switching pattern.

8. The system of claim 1, further comprising a controller configured to control the linear regulator to output the regulated voltage at a selected voltage level.

9. The system of claim 1, further comprising a controller configured to:
receive one or more signals representing one or more output voltage levels of the switched capacitor converter; and
control the linear regulator to output a selected voltage level to the switched capacitor converter, thereby adjusting one or more voltage levels output from the switched capacitor converter to one or more reference voltage levels.

10. The system of claim 1, wherein an output reference of the linear regulator is selected from among multiple discrete regulation points.

11. The system of claim 1, wherein the switched capacitor converter is reconfigurable to output one of a plurality of different sets of voltage levels related to the regulated voltage.

12. The system of claim 1, wherein the switched capacitor converter is configured to maintain at least three voltage rails, wherein a voltage difference between a first of the voltage rails and a second of the voltage rails is the same as a voltage difference between the second of the voltage rails and a third of the voltage rails.

13. The system of claim 1, wherein the switched capacitor converter is configured to output a set of voltage levels comprising at least the regulated voltage, two thirds of the regulated voltage, and one third of the regulated voltage.

14. The system of claim 1, wherein the switched capacitor converter is configured to output a set of voltage levels comprising the regulated voltage and one half of the regulated voltage.

15. The system of claim 1, wherein the switched capacitor converter comprises a first stage and a second stage coupled together by at least two voltage rails.

16. The system of claim 15, wherein one of the at least two voltage rails comprises a voltage of zero volts.

17. The system of claim 1, wherein the switched capacitor converter comprises
a first stage coupled between the regulated voltage output by the linear regulator and a ground voltage, and
a second stage differentially coupled between the regulated voltage output by the linear regulator and a voltage level output by the first stage.

18. The system of claim 1, wherein the switched capacitor converter is configured to output a set of voltage levels comprising a voltage greater than the regulated voltage.

19. The system of claim 1, further comprising a controller configured to:
control the linear regulator to output the regulated voltage at a selected voltage level; and
control the switched capacitor converter to output a set of different voltage levels proportional to the regulated voltage to the supply modulator.

20. The system of claim 1, wherein the switched capacitor converter is reconfigurable to operate in at least two different operating modes, a first of the at least two different operating modes outputting a first set of voltage levels proportional to the regulated voltage, and a second of the at least two different operating modes outputting a second set of voltage levels proportional to the regulated voltage, the second set being different from the first set.

21. The system of claim 1, wherein the switched capacitor converter comprises a network of switches and capacitors, further comprising a controller, wherein the controller is configured to control the network of switches to reconfigure the switched capacitor converter to operate in one of at least two different operating modes, wherein the switched capacitor converter generates at least two sets of voltage levels proportional to the regulated voltage.

22. The system of claim 8, wherein the controller is further configured to:
detect a voltage level of the energy source; and
select the voltage level of the regulated voltage based on the detected voltage level.

23. The system of claim 1, further comprising a controller configured to:
detect a voltage level of the energy source; and
reconfigure the switched capacitor converter to operate in one of at least two different operating modes based on the detected voltage level.

24. The system of claim 1, further comprising a controller configured to:
receive a signal related to at least one of a voltage level of the energy source or a desired RF output power of the RF amplifier; and
select a voltage level of the regulated voltage and/or reconfigure the switched capacitor converter based on the received signal.

25. The system of claim 1, further comprising a controller configured to:
receive a signal related to a voltage level output by the switched capacitor converter to the supply modulator; and
select a voltage level of the regulated voltage and/or reconfigure the switched capacitor converter based on the received signal.

26. The system of claim 1, wherein the linear regulator is a first linear regulator of a plurality of linear regulators and the regulated voltage is a first regulated voltage, further comprising a controller configured to:
receive a signal related to at least one of a voltage level of the energy source or a desired RF output power of the RF amplifier; and
control one of the linear regulators other than the first linear regulator to draw power at the input terminals and to output a second regulated voltage different than the first regulated voltage to the switched capacitor converter.

27. The system of claim 1, further comprising a controller configured to:
control the linear regulator to output the regulated voltage at a selected level based on an operating mode of the switched capacitor converter.

28. The system of claim 1, wherein the supply modulator can be controlled to select a voltage of zero volts.

29. The system of claim 1, wherein an output of the supply modulator is coupled to an output stage of the RF amplifier, and a level of the switched capacitor converter is coupled to a driver stage of the RF amplifier.

30. The system of claim 1, wherein the supply modulator comprises a first supply modulator, further comprising a second supply modulator, wherein the first supply modulator is configured to supply a first voltage level from the switched capacitor converter to a first stage of the RF amplifier, and the second supply modulator is configured to supply a second voltage level from the switched capacitor converter to a second stage of the RF amplifier.
